(19) United States
(12) Patent Application Publication
(10) Pub. No.: US 2008/0195827 A1
(43) Pub. Date: Aug. 14, 2008

(54) Storage control device for storage virtualization system

(75) Inventor: Nobuyuki Saika, Yokosuka (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/007,162

(22) Filed: Jan. 7, 2008

(30) Foreign Application Priority Data
Feb. 8, 2007 (JP) 2007-029658

(51) Int. Cl. G06F 12/00

(52) U.S. Cl. 711/162; 711/E12.001

(57) ABSTRACT

The same backup timing information is stored respectively in two or more storage control devices, of a plurality of storage control devices constituting a storage virtualization system which presents a virtual name space, which have objects which correspond to object names belonging to a particular range which is all or a portion of the virtual name space. The two or more storage control devices respectively back up the objects at timing indicated by the stored backup timing information.

### CROSS-REFERENCE TO PRIOR APPLICATION

This application relates to and claims the benefit of priority from Japanese Patent Application number 2007-29658, filed on Feb. 8, 2007 the entire disclosure of which is incorporated herein by reference.

### BACKGROUND

The present invention relates to storage virtualization technology.

In general, storage virtualization technology (also called a storage grid) is known. The virtualization used in storage virtualization technology may be virtualization at the file level or virtualization at the block level. One method for virtualization at the file level is global name space technology. According to global name space technology, it is possible to present a plurality of file systems which correspond respectively to a plurality of NAS (Network Attached Storage) systems, as one single virtual file system, to a client terminal.

In a system based on storage virtualization technology (hereinafter, called storage virtualization system), which is constituted by a plurality of storage control devices, when acquiring a backup (for example, a snapshot), it is necessary to send a backup acquisition request to all of the storage control devices (see, for example, Japanese Patent Application Publication No. 2006-99406).

The timing at which backup is executed (hereinafter, called the backup timing) may differ between the plurality of storage control devices which constitute the storage virtualization system. In other words, the backup timings may not be synchronized between the plurality of storage control devices.

In a first specific example, there may be a difference in timing at which a backup acquisition request arrives at each of the storage control devices constituting the storage virtualization system, due to the status of the network to which all of the storage control devices are connected, or the transmission sequence of the backup acquisition request, or the like. It is considered that problems of this kind are more liable to arise in cases where the storage virtualization system is large in scale.

In a second specific example, in cases where a storage control device that was previously operating on a stand alone basis is incorporated incrementally into the storage virtualization system, then that storage control device may not be provided with a backup section (for example, a computer program which acquires a backup), or the storage control device may have a different backup timing.

In cases such as those described above, in a plurality of storage control devices, the timing at which a backup of an object is acquired may vary, or backup of an object may not be carried out at all. Therefore, it is not possible to restore all of the plurality of objects in the storage virtualization system, to states corresponding to the same time point. For example, in a storage virtualization system which presents one virtual name space (typically, a global name space), supposing that a plurality of objects in the storage virtualization system are restored by a method of some kind and the plurality of restored objects are presented to a client using a single virtual name space, the time points of the plurality of objects represented by this virtual name space are not uniform. For example, files having different backup acquisition time points (for example, a file which has been returned to a state one hour previously and a file which has been returned to a state one week previously) are mixed together under one virtual name space.

### SUMMARY

Consequently, one object of the present invention is to synchronize the backup timings of a plurality of storage control devices which constitute a storage virtualization system.

Other objects of the present invention will become apparent from the following description.

The same backup timing information is stored respectively in two or more storage control devices, of a plurality of storage control devices constituting a storage virtualization system which presents a virtual name space, the two or more storage control devices having objects which correspond to object names belonging to a particular range which is all or a portion of the virtual name space. Rather than executing backup in response to receiving a backup acquisition request, the two or more storage control devices respectively back up the objects at the timing indicated by the stored backup timing information.

### BRIEF DESCRIPTION OF THE DRAWINGS

FIG. 1 shows an example of the composition of a computer system relating to a first embodiment of the present invention;

FIG. 2A shows one example of the computer programs of a master NAS device;

FIG. 2B shows one example of the computer programs of a slave NAS device;

FIG. 3A shows a plurality of types of logical volumes which are present in a storage system;

FIG. 3B is a diagram showing one example of a COW operation for acquiring a snapshot;

FIG. 4A illustrates the downloading of a schedule change monitoring sub-program, from a master NAS device to a slave NAS device;

FIG. 4B illustrates the reflecting of schedule information, from a master NAS device to slave NAS devices. FIG. 4C shows one modification of the reflecting of schedule information.

FIG. 5 illustrate the addition of a new NAS device to a GNS system;

FIG. 6A illustrates the downloading of a checking program from a master NAS device to an added slave NAS device;

FIG. 6B illustrates the downloading of a schedule change monitoring sub-program, from a master NAS device to an added slave NAS device;

FIG. 6C illustrates the reflecting of schedule information, from a master NAS device to an added slave NAS device;

FIG. 7A shows the acquisition of schedule information from the master NAS device (NAS-00), by all of the slave NAS devices (NAS-01 to NAS-05).

FIG. 7B shows the acquisition of schedule information from a new master NAS device (NAS-01), by all of the slave NAS devices (NAS-02 to NAS-05), after a fail-over from NAS-00 to NAS-01;

FIG. 8 shows an overview of the sequence of processing executed respectively by a GNS definition change monitoring sub-program, a checking program, and a schedule change monitoring sub-program;

FIG. 9 shows a flowchart of processing executed by the GNS definition change monitoring sub-program;

FIG. 10A shows a flowchart of processing executed by the checking program;

FIG. 10B shows an example of the composition of a table for managing the presence or absence of an snapshot/restore program in each of the NAS devices;

FIG. 10C shows a flowchart of processing executed by the schedule change monitoring sub-program;

FIG. 11 shows designation of a desired directory point in the GNS by an administrator;

FIG. 12A shows a first example of a schedule acceptance screen;

FIG. 12B is an illustrative diagram shows one example of a transfer log and a first method for calculating correlation amounts;

FIG. 13A shows one example of a computer program provided additionally in a master NAS device according to a second embodiment of the present invention;

FIG. 13B is an illustrative diagram of a third method of calculating correlation amounts;

FIG. 14 is a diagram for describing the relationship between respective client groups and files used by respective client groups, in a third embodiment of the present invention;

FIG. 15 is a diagram showing one example of the creation of a new file share having an actual entity, and the migration of files;

FIG. 16 shows one example of the creation of a new virtual file share;

FIG. 17 shows one example of a computer program provided in the master NAS device according to a third embodiment of the present invention;

FIG. 18 shows a flowchart of processing executed by a file share settings monitoring sub-program;

FIG. 19A shows a first example of a schedule settings screen;

FIG. 19B shows a flowchart of processing executed by the screen operation acceptance sub-program;

FIG. 20A is an illustrative diagram of the active notification of schedule information to slave NAS devices, by the master NAS device, according to a fourth embodiment of the present invention;

FIG. 20B shows a flowchart of the processing of a schedule change monitoring sub-program according to the fourth embodiment of the present invention;

FIG. 21 shows a restore request from a management terminal to a master NAS device;

FIG. 22 shows the specification of a designated restore range by comparing a directory point specified in a restore request with the GNS definition information;

FIG. 23 shows the transmission of a mount and share request to a slave NAS device having an object belonging to the designated restore range;

FIG. 24 shows one example of mounting (restoring) a snapshot;

FIG. 25 shows a sub-program relating to the mounting of the snapshot, in the snapshot/restore program;

FIG. 26 shows a sequence of processing executed in the mount request acceptance sub-program, and a sequence of processing executed in the mount sharing setting sub-program;

FIG. 27 shows examples of the respective hardware compositions of a NAS device and a storage system connected to same; and

FIG. 28 shows a specific example of the composition of a GNS.

### DETAILED DESCRIPTION OF THE PREFERRED EMBODIMENTS

Several embodiments of the present invention are described below. Before describing these several embodiments in detail, a general summary will be given.

One storage control device (hereinafter, a first storage control device) of a plurality of storage control devices which constitute a storage virtualization system which presents a virtual name space (for example, a global name space) comprises a storage control device identification section and a backup timing synchronization section. On the basis of the virtualization definition information, which is information representing the respective locations within the storage virtualization system of the objects corresponding to the object names in the virtual name space, the storage control device identification section identifies two or more other storage control devices (hereinafter, called “second storage control devices”), of the plurality of storage control devices, which respectively have an object corresponding to an object name belonging to a particular range, which is all or a portion of the virtual name space. The backup timing synchronization section sends backup timing information, which is information indicating a timing for backing up of the object (the backup timing information being stored, for example, in a first storage extent managed by the first storage control device), to the two or more second storage control devices identified above. Each of the two or more second storage control devices stores the received backup timing information in a second storage extent managed by that storage control device. The backup section provided in each of the two or more second storage control devices backs up the object at the timing indicated by the backup timing information stored in the second storage extent.

The object may be any one of a file, a directory and/or a file system, for example.

For at least one of the plurality of storage control devices, it is possible to use various types of apparatus, such as a switching device, a file server, a NAS device, a storage system constituted by a NAS device and a plurality of storage apparatuses, and the like.

The first and the second storage extents may exist at least one of a main storage apparatus and an auxiliary storage apparatus provided in the storage control device, or they may be exist in an external storage apparatus connected to the storage control device (for example, a storage resource inside the storage system).

In one embodiment, the first storage control device also comprises a virtualization definition monitoring section. The virtualization definition monitoring section monitors the presence or absence of an update of the virtualization definition information, and in response to detecting an update, it executes processing in accordance with the difference between the virtualization definition information before update and the virtualization definition information after update.

In this embodiment, the first storage control device may also comprise a checking section, which is a computer program. If the difference is a storage control device ID, which is not included in the virtualization definition information before update but is included in the virtualization definition information after update, in other words, if a new second storage control device has been added to the storage virtualization system, then the virtualization definition monitoring section is able to send a checking section to the second storage control device identified on the basis of the storage control device ID, as a process corresponding to the aforementioned difference. By executing the checking section by means of the processor of the second storage control device forming the transmission target, it is possible to check whether or not the second storage control device comprises a backup section.

Moreover, in this embodiment, the first storage control device can also comprise a backup timing acquisition section, which is a computer program which interacts with the backup timing synchronization section, and a transmission section which sends the backup timing acquisition section to a second storage control device, in response to a prescribed signal from the checking section. The checking section can receive the backup timing acquisition section by sending a prescribed signal (for example, the ID of the second storage control device executing the checking section), to the first storage control device. In the first storage control device, in response to receiving the prescribed signal from the checking section, the transmission section is able to send the backup timing acquisition section, to the second storage control device forming the transmission source of the information. By executing the backup timing acquisition section in the second storage control device forming the transmission source, it is possible to store the backup timing information received from the first storage control device, in the second storage extent. On the other hand, if the result of the aforementioned check indicates that no backup section is provided in the second storage control device, then the checking section is able to migrate the objects managed by the second storage control device executing this checking section, to a storage control device provided with a backup section, and to send information relating to the migration target of the objects (for example, the ID of the storage control device forming the migration target), to the first storage control device. In this case, the checking section may also send information relating to the migration result (for example, the local path before migration and the local path after migration, for each of the migrated objects), to the virtualization definition monitoring section. The virtualization definition monitoring section can then update the virtualization definition information on the basis of the ID of the migration target storage control device and the information relating to the migration result, thus received. The migration target storage control device may be a second storage control device, or it may be a spare storage control device which is different to the first and second storage control devices.

In one embodiment, the backup timing synchronization section is able to send backup timing information to second storage control devices which respectively have objects having a particular correlation, of the plurality of objects present in the two or more second storage control devices. In this case, the backup timing synchronization section can also send an ID indicating on object desired by the user, in addition to the backup timing information. The second storage control device is able to store the object ID and the backup timing information as a set, in the second storage extent. The backup section of the second storage control device is able to back up the object corresponding to the stored object ID, of the plurality of objects managed by that second storage control device, at the timing indicated by the stored backup timing information. In this embodiment, for example, if the objects of a newly added second storage control device are not objects having a particular correlation, then the checking section does not have to be sent to that second storage control device.

In one embodiment, the backup section is composed in such a manner that, when the objects are backed up at the timing indicated by the received backup timing information, the objects which are backed up, namely, the backup objects, are stored in association with the timing at which backup was executed, and when a restore request including information indicating the backup timing is received, the backup objects associated with the backup timing indicated by this information are restored, and information indicating the access target path to the restored backup objects is sent back to the transmission source of the information indicating the backup timing. The first storage control device can also comprise a restore control section. The restore control section sends a restore request including information indicating a backup timing, to the two or more other storage control devices, and in response to this, it receives information indicating the access target path to the restored backup objects, from the two or more other storage control devices, and can then update the virtualization definition information on the basis of the information thus received. The virtualization definition information after update includes information in which the object name representing a restored backup object is expressed as a virtual name space, and information indicating the storage location within the storage virtualization system of the object corresponding to this object name (for example, the received information indicating the access path to the restored backup object).

The respective sections described above (for example, the backup section, the backup timing synchronization section, the virtualization definition monitoring section, the restore control section, and the like) can be constituted by hardware, a computer program or a combination of these (for example, a portion thereof is realized by a computer program and the remainder thereof is realized by hardware). The computer program is executed by being read into a prescribed processor. Furthermore, in the case of information processing which is carried out by reading a computer program into a processor, it is also possible to use an existing storage extent of the hardware resources, such as a memory, as appropriate. Furthermore, the computer program may be installed in the computer from a storage medium, such as a CD-ROM, or it may be downloaded to the computer by means of a communications network. Furthermore, the storage device may be a physical or a logical device. Physical storage devices may be, for example, a hard disk, a magnetic disk, an optical disk, a magnetic tape, or a semiconductor memory. A logical storage device may be a logical volume.

Below, several embodiments of the present invention are described in detail with respect to the drawings. In this case, a storage virtualization system which presents a global name space (hereinafter, called a GNS system), is described as an example.

### First Embodiment

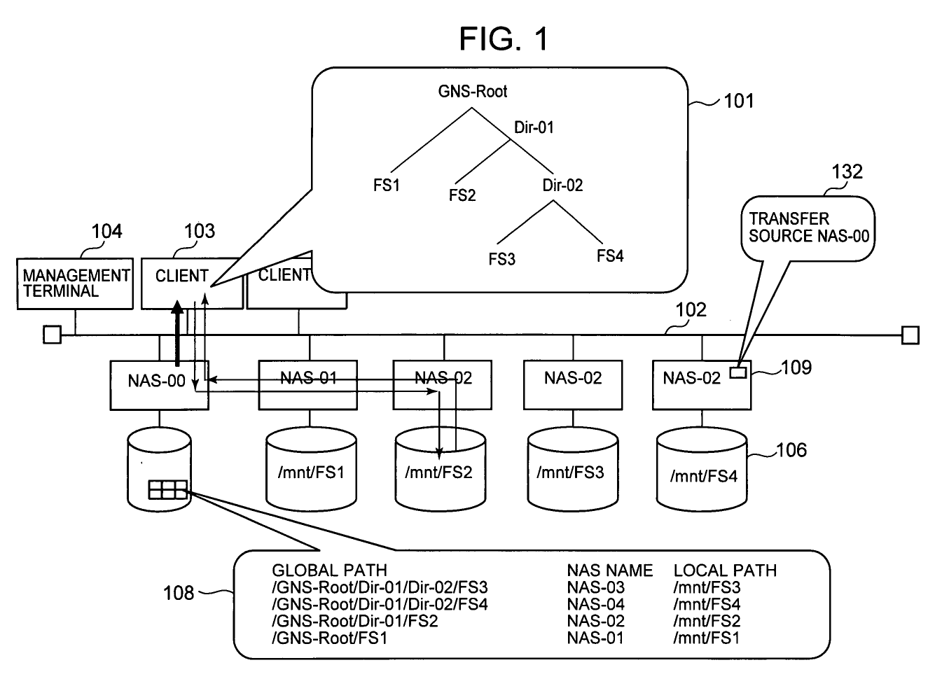

FIG. 1 shows an example of the composition of a computer system relating to a first embodiment of the present invention.

A plurality of (or one) client terminals 103, a management terminal 104, and a plurality of NAS devices 109 are connected to a communications network (for example, a LAN (Local Area Network)) 102. A file system 106 is mounted respectively on each of the plurality of NAS devices 109. Each file system 106 has functions for managing the files contained therein, and an interface for enabling access to the files. One file system 106 may serve to manage all or a portion of one logical volume, or it may serve to manage a plurality of logical volumes. Furthermore, the management terminal 104 and the client terminal 103 may be the same device. In this case, the client user (the person using the files), and the administrator are one and the same person.

A GNS system is constituted by means of a plurality of NAS devices 109. The plurality of NAS devices 109 include a first NAS device (hereinafter, called “master NAS”) and second NAS devices (hereinafter, called “slave NAS”). The master NAS device presents the global name space 101, as a single virtual file system, to the client terminal 103. The slave NAS devices each comprise a file system which manages objects corresponding to the object names represented by the global name space 101. Below, the file system of the master NAS device is called the “master file system”, and the file system of a slave NAS device is called the “slave file system”. The plurality of NAS devices 109 may also include a spare NAS device. The spare NAS device can be used as a standby NAS device for the master NAS device or the slave NAS devices.

The master NAS device manages GNS definition information 108, for example. The GNS definition information 108 may be stored in the storage resources inside the master NAS. The GNS definition information 108 is information expressing definitions of which local path is used with respect to the NAS device having which ID. More specifically, for example, in the GNS definition information 108, a NAS name and a local path are associated, for each of the global paths. The administrator is able to update the GNS definition information 108 via the management terminal 104. In the GNS definition information 108 in the example shown, the global path and the local path both indicate a path up to a file system (in other words, they are path names which terminate in a file system name), but it is also possible to specify a more detailed path, for example, by using a character string indicating the file system name (for example, FS3), and adding a character string (for example, file A) indicating an object (for example, a file) managed by the file system corresponding to the file system name, to the end of the file system name.

The master NAS device (NAS-00) is able to present the global name space (hereinafter, GNS) 101 shown in the drawing, to the client terminal 103, on the basis of all of the global paths recorded in the GNS definition information 108. By accessing the master NAS device (NAS-00), the client terminal 103 is able to refer to GNS 101 (for example, it is possible to display a view of the GNS 101 by carrying out an operation similar to that of referring to a file or directory in Windows Explorer (registered trademark)).

Below, the sequence of the interaction between the client terminal 103 and the master NAS device, and the interaction between the master NAS device and the slave NAS devices, will be described. This description relates to the logical sequence, and a more detailed description of the sequence in line with the protocol specifications will given further below. Furthermore, in the following description, the respective nodes in the tree in GNS 101 are called “tree nodes”.

For example in GNS 101, the object name “a.txt” is positioned directly below /GNS-Root/Dir-01/FS2 (in other words, the object name (FS2)). Furthermore, the file corresponding to the object name “a.txt” is contained in the slave file system (FS2) of the slave NAS device (NAS-02). In this case, when referring to the file “a.txt”, the client terminal 103 sends a reference request (read command) in line with the first access path in the GNS 101 “/GNS-Root/Dir-01/FS2/a.txt”, to the master NAS device (NAS-00). In response to receiving the reference request, the master NAS device (NAS-00) acquires the NAS name “NAS-02” and the local path “/mnt/FS2” corresponding to the global path “/GNS-Root/Dir-01/FS2” contained in the first access path, from the GNS definition information 108. The master NAS device (NAS-00) prepares a second access path “/mnt/FS2/a.txt”, by adding the differential between the first access path “/GNS-Root/Dir-01/FS2/a.txt” and the global path “/GNS-Root/Dir-01/FS2”, namely, “/a.txt”, to the acquired local path “/mnt/FS2”. The master NAS device (NAS-00) transfers a reference request to the slave NAS (NAS-02) corresponding to the acquired NAS name “NAS-02”, in accordance with the second access path “/mnt/FS2/a.txt”. Upon receiving the reference request in accordance with the second access path, the slave NAS device (NAS-02) reads the file “a.txt” corresponding to this reference request, from the slave file system (FS2), and sends the file “a.txt” thus read, to the transfer source of the access request (the master NAS device (NAS-00)). Moreover, the slave NAS device (NAS-02) records the NAS name “NAS-00” of the transfer source of the reference request, in an access log 132 that is held by the slave NAS itself. The access log 132 may be a storage resource inside the NAS device 109, or it may be located in the file system mounted on the NAS device 109. The master NAS device (NAS-00) sends the file “a.txt” received from the slave NAS (NAS-02), to the client terminal 103 forming the transmission source of the reference request based on the first access path.

The foregoing was an overview of a computer system relating to the present embodiment.

In the foregoing description, upon receiving a reference request based on a first access path, the master NAS device (NAS-00) may send the local path and the NAS name (or the object ID (described hereinafter) and NAS name) corresponding to the global path in the first access path, to the client terminal 103. In this case, the client terminal may send a reference request based on a second access path, which includes the local path thus received, to the NAS device identified by the NAS name thus received. When sending this reference request, the client terminal may include the NAS name of the NAS device forming the notification source of the local path, or the like, in the reference request. The NAS device which receives this reference request may record the NAS name contained in the reference request, in an access log. The NAS name thus recorded is, effectively, the name of a master NAS. In the foregoing description, a reference request can also be used in the case of an update request (write command).

Furthermore, in the example illustrated, the NAS name recorded in the GNS definition information 108 is the name of a slave NAS device, but the NAS name is not limited to the name of a slave NAS device and it is also possible to record the name of a master NAS device. In other words, it is also possible to include a name indicating at least one of a master file system, and/or a directory or file managed by a master file system, in the plurality of names represented by the GNS 101.

Below, the present embodiment shall be described in more detail.

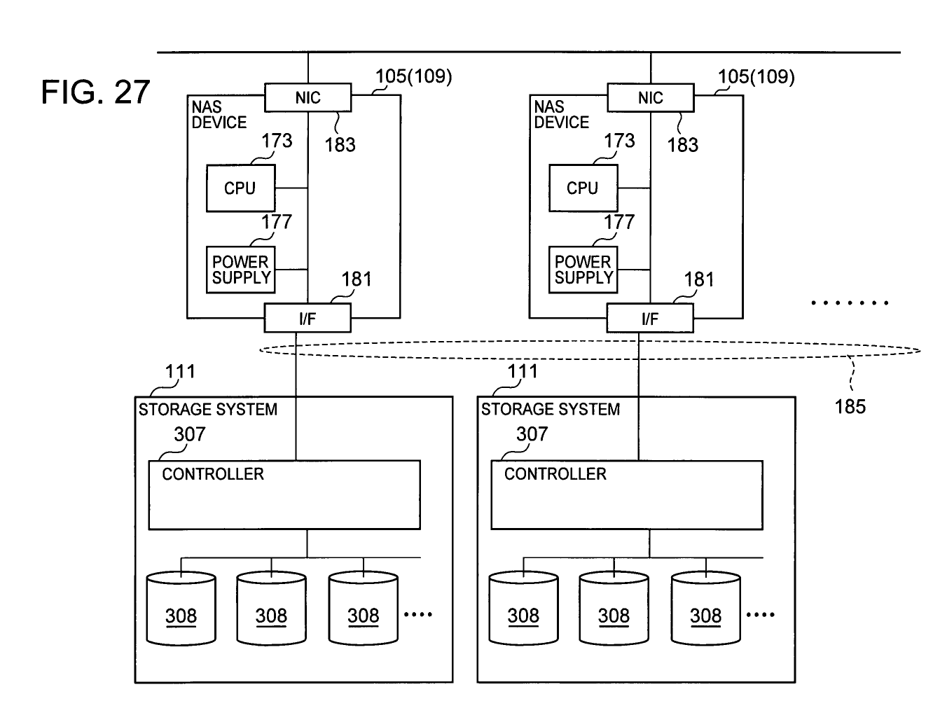

FIG. 27 shows examples of the respective hardware compositions of a NAS device and a storage system connected to same.

The NAS devices 109 are connected to storage systems 111 via a communications network 185, such as a SAN (Storage Area Network), or dedicated cables. It is possible to connect a plurality of NAS devices 109 and one or more than one storage system 111 to the communications network 185. In this case, the plurality of NAS devices 109 may access different logical volumes in the same storage system 111. The storage resources of a storage system 111 (for example, one or more logical volume) are mounted on a NAS device 109, as a file system.

Each storage system 111 comprises a plurality of physical storage apparatuses (for example, a hard disk drive or flash memory) 308, and a controller 307 which controls access to the plurality of physical storage apparatuses 303. A plurality of logical volumes (logical storage apparatuses) are formed on the basis of the storage space presented by the plurality of physical storage apparatuses 308. The controller 307 is an apparatus comprising a CPU and a cache memory, or the like, which temporarily stores the processing results of the CPU. The controller 307 receives access requests in block units, from the NAS device 109 (for example, the device driver of the NAS device 109 (described hereinafter)), and writes data or reads data in accordance with the access request, to or from the logical volume according to access request.

The NAS device 109 comprises a CPU 173, a storage resource 177, an interface (I/F) 181, and a Network Interface Card (NIC) 183. The NAS device 109 communicates with the storage system 111 via the interface 181. The NAS device 190 communications with other NAS devices 109 via the NIC 183. The storage resource 177 can be constituted by at least one of a memory and/or a disk drive, for example, but it is not limited to this composition and may also be composed by storage media of other types.

The storage resource 177 stores a plurality of computer programs, and these computer programs are executed by the CPU 173. Below, if a computer program is the subject of an action, then this actually refers to a process which is carried out by the CPU executing that computer program.

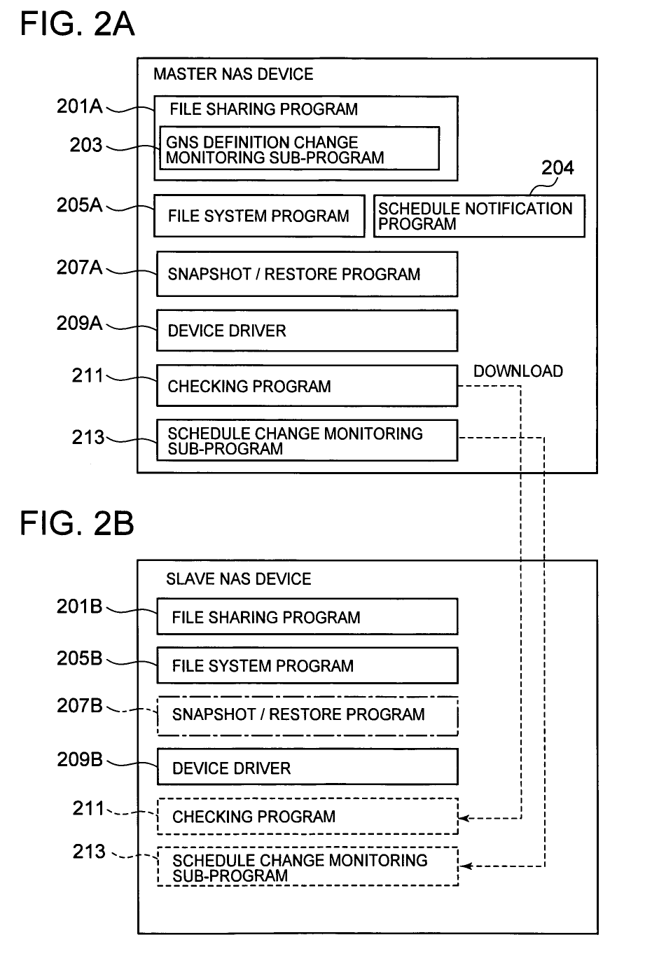

FIG. 2A shows one example of the computer programs of a master NAS device.

The master NAS comprises a file sharing program 201A, a file system program 205A, a schedule notification program 204, a snapshot/restore program 207A, a device driver 209A, a checking program 211, and a schedule change monitoring sub-program 213.

An OS (Operating System) layer is constituted, for example, by the file system program 205A, the snapshot/restore program 207A and the device driver 209A. The file system program 205A is a program which controls the mounted file system, and it is able to present the mounted file system, in other words, a logical view having a hierarchical structure (for example, a view showing the hierarchical structure of the directories and files), to the upper layer. Moreover, the file system program 205A is able to execute I/O processes with respect to lower layers (for example, a block data I/O request), by converting the logical data structure in this view (for example, the file and file path), to a physical data structure (for example, block level data and a block level address). The device driver 209A is a program which executes a block I/O requested by the file system program 205A. The snapshot/restore program 207A holds a static image of the file system at a certain time, and is able to restore this image. The unit in which snapshots are taken is not limited to the whole file system, and it may also be a portion of the file system (for example, one or more file), but in the present embodiment, in order to facilitate the description, it is assumed that a snapshot taken in one NAS device is a static image of one file system.

The file sharing program 201A presents a file sharing protocol (for example, NFS (Network File System) or CIFS (Common Internet File System)), to a client terminal 103 connected to the communications network 102, thus providing a file sharing function for a plurality of client terminals 103. The file sharing program 201A accepts access requests in file units, from a client terminal 103, and requests (write or read) access in file units, to the file system program 205A. Furthermore, the file sharing program 201A also has a GNS function whereby a plurality of NAS devices 109 are handled as one virtual NAS device.

The file sharing program 201A has a GNS definition change monitoring sub-program 203. The GNS definition change monitoring sub-program 203 monitors the GNS definition information 108, and executes prescribed processing if it detects that the GNS definition information 108 has been updated, as a result of monitoring. The GNS definition change monitoring sub-program 203 is described in detail below.

The schedule notification program 204 is able to report schedule information stored in the storage extent managed by the master NAS device (hereinafter, called the master storage extent), to the slave NAS devices. More specifically, for example, if the schedule change monitoring sub-program 213 executed in a slave NAS device is composed so as to acquire schedule information from the master NAS device, as described below, then the schedule notification program 204 is able to respond to this request from the schedule change monitoring sub-program 213 and send the schedule information stored in the master storage extent, to the schedule change monitoring sub-program 213 executed by the slave NAS device. In this case, the schedule change monitoring sub-program 213 is able to store the received schedule information, in a storage extent managed by the slave NAS device (hereinafter, called “slave storage extent”). The master storage extent may be located in the storage resource 177 of the master NAS device, or it may be located in a storage resource outside the master NAS device (for example, the master file system). Similarly, the slave storage extent may be located in the storage resource 177 of the slave NAS device or it may be located in a storage resource outside the slave NAS device (for example, the slave file system).

The checking program 211 and the schedule change monitoring sub-program 213 are programs which are executed in a slave NAS device by being sent to the slave NAS device. The checking program 211 checks whether or not there is a snapshot/restore program 207B in the slave NAS device forming the transmission target. The schedule change monitoring sub-program 213 acquires schedule information from the master NAS device. These programs are described in more detail below.

FIG. 2B shows one example of the computer programs of a slave NAS device.

The slave NAS device has a file sharing program 201B, a file system program 205B, a snapshot/restore program 207B and a device driver 209B.

The file sharing program 201B does not comprise a GNS function or the GNS definition change monitoring sub-program 203, but it is substantially the same as the file sharing program 201A in respect of the functions apart from these. The file system program 205B, the snapshot/restore program 207B and the device driver 209B are each substantially the same, respectively, as the file system program 205A, the snapshot/restore program 207A and the device driver 209A.

There may also be slave NAS devices which do not have the snapshot/restore program 207B. The checking program 211 downloaded from the master NAS device to a slave NAS device and executed in the slave NAS device checks whether or not a snapshot/restore program 207B is present in the slave NAS device.

Below, a COW (Copy On Write) operation for acquiring a snapshot by means of the snapshot/restore program 207B will be described. Before this, however, the types of logical volumes present in the storage system 111 will be described.

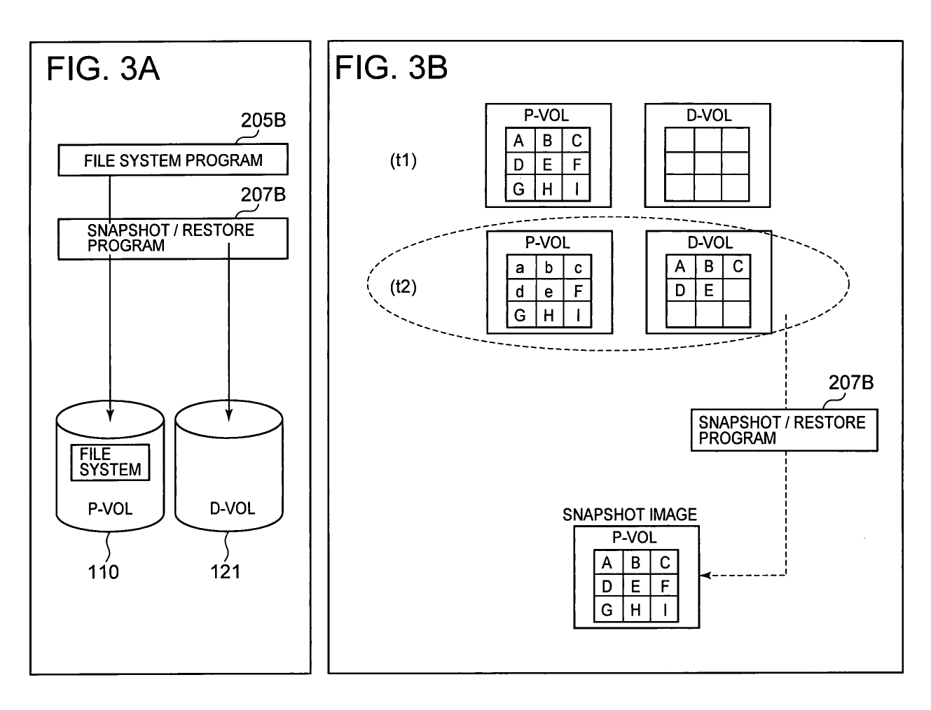

FIG. 3A shows a plurality of types of logical volumes which are present in the storage system 111.

Here, the plurality of types of logical volumes are a primary volume 110 and a differential volume 121.

The primary volume 110 is a logical volume storing data which is read out or written in accordance with access requests sent from a NAS device 109. The file system program 205B (205A) in the NAS device 109 accesses the primary volume 110 in accordance with a request from a file sharing program 209B (209A).

The differential volume 121 is a logical volume which forms a withdrawal destination for old block data before update, when the primary volume 110 has been updated. The file system of the primary volume 110 is mounted on the file system program 205B (205A), but the file system of the differential volume 121 is not mounted.

In this case, when block data is written to any particular block of the primary volume 110 from the file system program 205B, the snapshot/restore program 207B withdraws the block data that was already present in that block, to the differential volume 121.

FIG. 3B is a diagram showing one example of a COW operation for acquiring a snapshot.

The primary volume 110 comprises nine blocks each corresponding respectively to the block numbers 1 to 9, for example, and at timing (t1), the block data A to I are stored in these nine blocks. This timing (t1) is the snapshot acquisition time based on the schedule information. The snapshot/restore program 207B is, for example, able to prepare snapshot management information associated with the timing (t1), on a storage resource (for example, a memory). The snapshot management information may comprise, for example, a table comprising entries which state the block number before withdrawal and the block number after withdrawal.

At the subsequent timing (t2), if new block data a to e have been written to the block numbers 1 to 5, then the snapshot/restore program 207B withdraws the existing block data A to E in the block numbers 1 to 5, to the differential volume 121. This operation is generally known as COW (Copy On Write). When the blocks in the primary volume 110 are updated for the first time after timing (t1), the snapshot/restore program 207B may, for example, include the withdrawal source block number, and the withdrawal destination block number which corresponds to this block number, in the snapshot management information associated with timing (t1). In other words, in the present embodiment, acquiring a snapshot means managing an image of the primary volume 110 at the acquisition timing, in association with information which expresses that acquisition timing.

After the timing (t2), when a restore (mount) of the snapshot at timing (t1) is requested, the snapshot/restore program 207B (207A) acquires the snapshot management information associated with that timing (t1), creates a virtual volume (snapshot) in accordance with that snapshot management information, and displays this on the file system 205B (205A). The snapshot/restore program 207B (207A) is able to access the primary volume 110 and the differential volume 121, via the device driver, and to create a virtual logical volume (virtual volume) which synthesizes these two volumes. The client terminal 103 is able to access the virtual volume (snapshot) via the file system and the file sharing function (the process for accessing the snapshot is described hereinafter).

In the present embodiment, the schedule information stored in the master storage extent of the master NAS device is sent to each of the slave NAS devices and stored in the slave storage extents of the respective NAS devices; and in each of the slave NAS devices, a snapshot is acquired at the respective timing according to the schedule information stored in the slave storage extent managed by the slave NAS device.

Below, one example of the sequence until the schedule information stored in the master storage extent is stored in a slave storage extent, will be described. In this case, the master NAS device is NAS-00 and the slave NAS device is NAS-01.

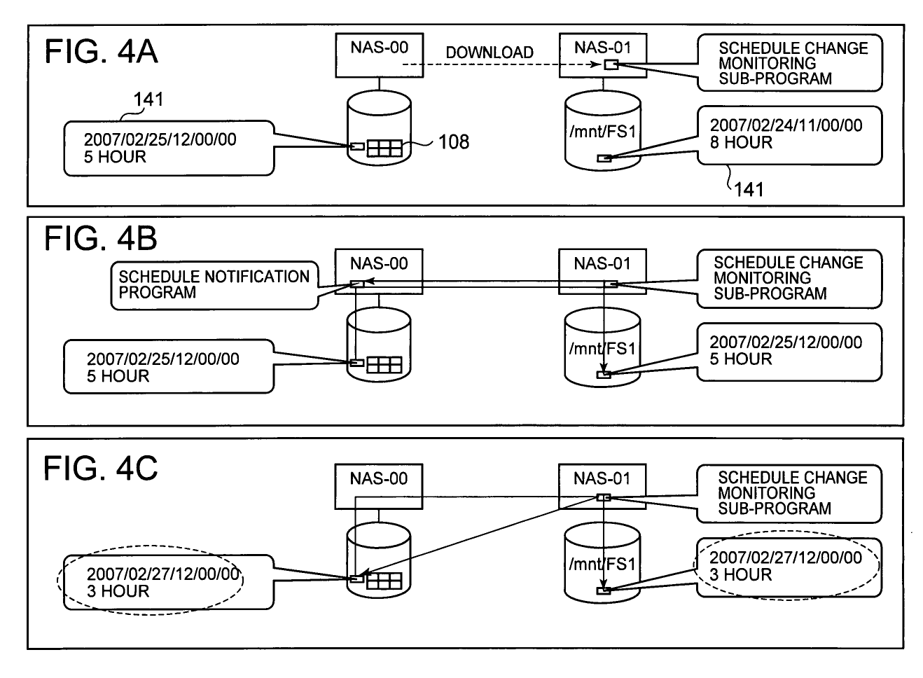

As shown in FIG. 4A, information constituted by “2007/02/25/12/00/00” and “5 hour” is stored as the schedule information 141, in the master storage extent. “5 hour” in an information element which indicates the time interval of snapshot acquisition (hereinafter, called the “snapshot acquisition interval”). “2007/02/25/12/00/00” is an information element indicating the start time of the acquisition time intervals (for example, a time that is at least a future time with respect to the date and time that the schedule information 141 was recorded). In other words, the schedule information 141 is constituted by an information element expressing the snapshot acquisition time interval and an information element expressing the start time of the snapshot acquisition time interval (hereinafter, called “acquisition interval start time”). Each of the timings according to this schedule information is a snapshot acquisition timing. The acquisition interval start time may be expressed in a “year/month/day/hour/minute/second” format. The schedule information is not limited to a combination of an information element expressing the snapshot acquisition time interval and an information element expressing the acquisition interval start time, and it may have a different composition, for instance, it may be constituted by information elements indicating one or more snapshot acquisition timings. The schedule information 141 stored in the master NAS device is information which has been input from the management terminal 104, for example.

Furthermore, as shown in FIG. 4A, schedule information 141 constituted by “2007/02/24/11/00/00” and “8 hour”, which is different to the schedule information 141 stored in the master storage extent, is stored in the slave storage extent.

The schedule change monitoring sub-program 213 is downloaded from the master NAS device (NAS-00) to the slave NAS device (NAS-01). By this means, the CPU of the slave NAS device (NAS-01) is able to execute the schedule change monitoring sub-program 213.

As shown in FIG. 4B, the schedule change monitoring sub-program 213 in the slave NAS device (NAS-01) acquires the schedule information 141 stored in the master storage extent, from the master NAS device (NAS-00). More specifically, for example, the schedule change monitoring sub-program 213 in the slave NAS device (NAS-01) requests the schedule information 141, from the schedule notification program 204 in the master NAS device (NAS-00), and the schedule notification program 204 sends the schedule information 141 stored in the master storage extent to the slave NAS device (NAS-01), in response to this request. The schedule change monitoring sub-program 213 in the slave NAS device (NAS-01) writes the acquired schedule information 141 over the existing schedule information 141 that was stored in the slave storage extent. Thereby, the contents of the schedule information 141 stored in the slave storage extent become the same as the contents of the schedule information 141 stored in the master storage extent. In other words, the snapshot acquisition timings of the master NAS device (NAS-00) and the slave NAS device (NAS-01) are synchronized.

The schedule change monitoring sub-program 213 is composed in such a manner that it acquires schedule information 141 from the master NAS device (NAS-00) and stores this information in the slave storage extent, at regular (or irregular) intervals. Therefore, if the schedule information 141 stored in the master storage extent is changed via the management terminal 104, for example, then the schedule change monitoring sub-program 213 in the slave NAS device (NAS-01) acquires the changed schedule information 141 from the master NAS device (NAS-00) and updates the schedule information 141 in the slave storage extent to match this changed schedule information 141. By this means, even if the snapshot acquisition timing is changed in the master NAS device (NAS-00), it is possible to synchronize the snapshot acquisition timing of the slave NAS device (NAS-01) with the changed snapshot acquisition timing of the master NAS device (NAS-00).

As shown in FIG. 4C, the schedule change monitoring sub-program 213 monitors the presence or absence of change in the schedule information 141 stored in the master storage extent, and hence it is possible to acquire the schedule information 141 from the master NAS device (NAS-00) and to overwrite the acquired schedule information 141 to the slave storage extent, only when the presence of a change has been detected.

Below, one processing sequence carried out in the present embodiment will be described.

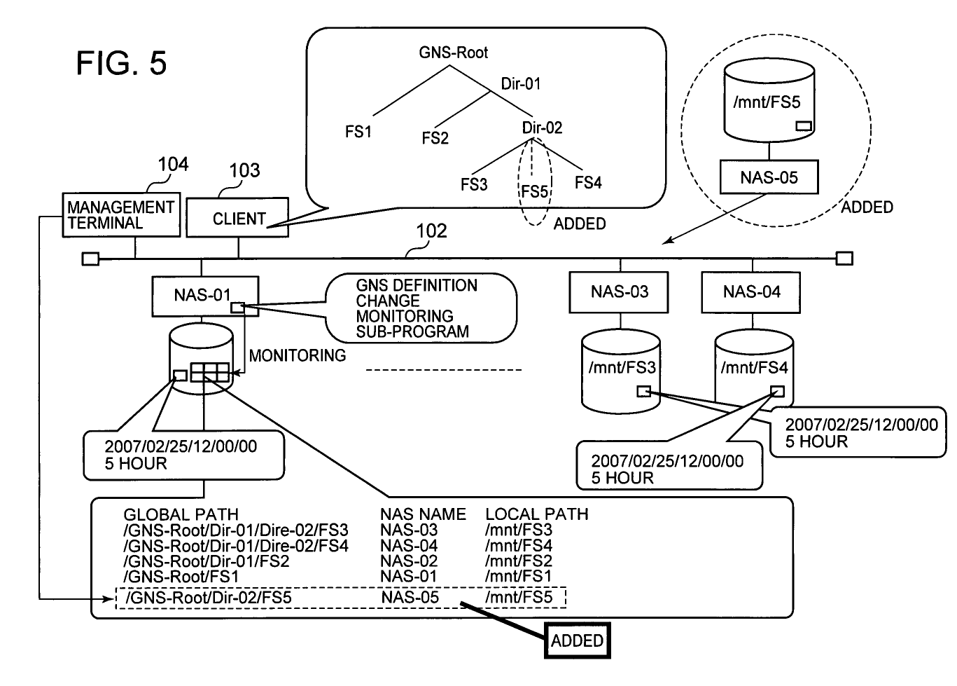

For example, as shown in FIG. 5, a GNS system is constituted by five NAS devices (NAS-00 to NAS-04). In the master NAS device (NAS-00), the GNS definition change monitoring sub-program 203 monitors whether or not a NAS device has been incorporated into the GNS system. More specifically, for example, it monitors whether or not there is a change to the GNS definition information 108.

Here, it is supposed that the slave NAS device (NAS-05) has been added to the GNS system. This does not mean that the NAS-05 has simply been connected to the communications network 102, but rather, that information relating to NAS-05 has been added to the GNS definition information 108. In the example shown in FIG. 5, a set of information elements relating to the global path “/GNS-Root/Dir-02/FS5”, the NAS name “NAS-05”, and the local path “/mnt/FS5”, is added to the GNS definition information 108. As stated above, the addition of this set of information elements, in other words, the change to the GNS definition information 108, can be carried out by the management terminal 104 (or it may be carried out by another computer instead of the management terminal 104).

The GNS definition change monitoring sub-program 203 monitors the presence or absence of change in the GNS definition information 108, and hence the addition of the aforementioned set of information elements is detected by the GNS definition change monitoring sub-program 203. If the GNS definition change monitoring sub-program 203 has detected that a set of information elements has been added to the GNS definition information 108, then it logs in from the master NAS device (NAS-00), to the slave NAS device (NAS-05) corresponding to the NAS name “NAS-05” contained in the set of information elements (hereinafter, this log in from a remote device is called “remote log-in”).

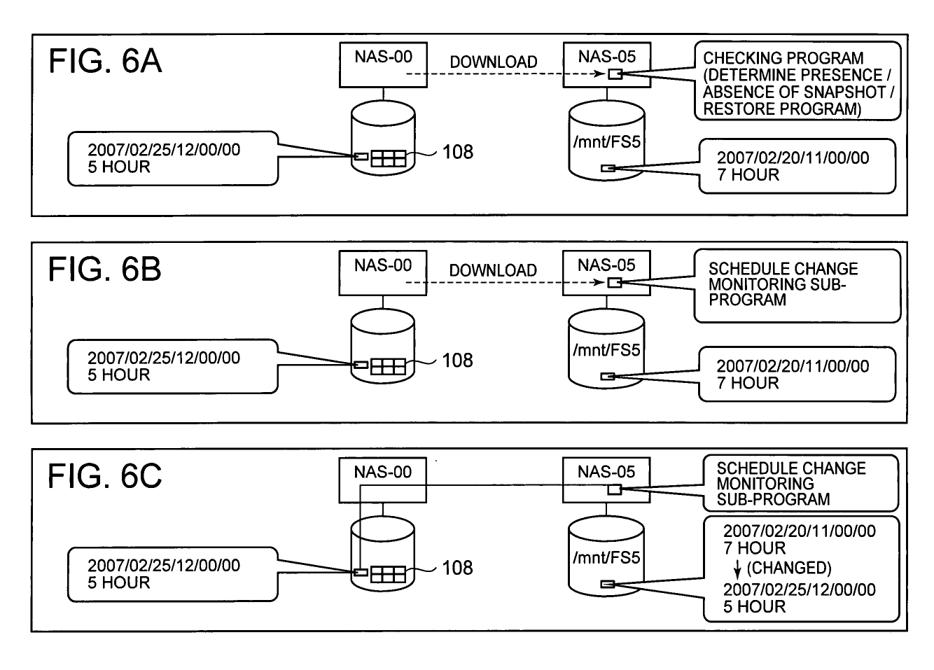

After completing remote log-in to the slave NAS device (NAS-05), the GNS definition change monitoring sub-program 203 downloads the checking program 211 to the slave NAS device (NAS-05), as shown in FIG. 6A. By this means, the CPU of the slave NAS device (NAS-05) is able to execute the checking program 211.

The checking program 211 judges whether or not there is a snapshot/restore program 207B in the slave NAS device (NAS-05). If, as a result of this check, it is judged that there is a snapshot/restore program 207B, then as shown in FIG. 6B, the checking program 211 downloads and starts up the schedule change monitoring sub-program 213, from the master NAS device (NAS-00). Thereupon, as shown in FIG. 6C, the schedule change monitoring sub-program 213 acquires the schedule information 141 from the master NAS device (NAS-00), and stores the schedule information 141 thus acquired in the slave storage extent of the slave NAS device (NAS-05).

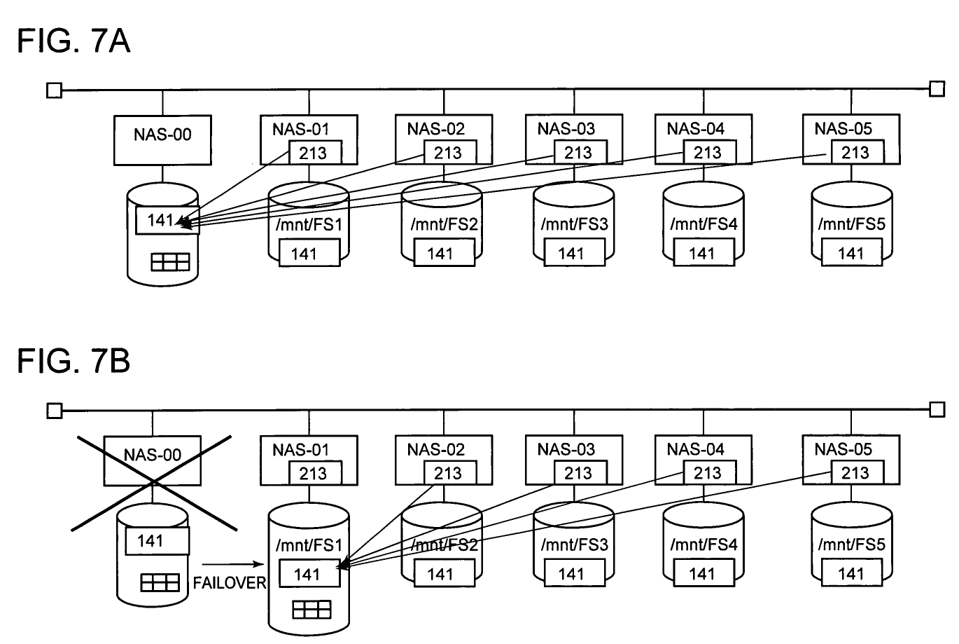

By means of the sequence of processing described above, it is possible to synchronize the snapshot acquisition timing of the slave NAS device (NAS-05) which has been added incrementally to the GNS system, with the snapshot acquisition timing of the master NAS device (NAS-00). Furthermore, as a result of the sequence of processing described above, as shown in FIG. 7A, the schedule change monitoring sub-program 213 in each of the respective slave NAS devices (NAS-01 to NAS-05) acquires the schedule information 141 from the master NAS device (NAS-00).

If, for example, a failure has occurred in the master NAS device (NAS-00), then a fail-over is executed from the master NAS device (NAS-00), to another NAS device. The other NAS device may be any one of the slave NAS devices, or it may be a spare NAS device. If a fail-over has been executed, then the GNS definition information 108 and the schedule information 141, and the like, is passed on to the NAS device forming the fail-over target. The schedule change monitoring sub-program 213 is composed in such a manner that it refers to the access log in the slave NAS device, identifies the NAS device having a valid GNS definition (in other words, the current master NAS device), from the access log, and then acquires the schedule information 141 from the NAS device thus identified. As shown in the example in FIG. 7B, after performing a fail-over from the master NAS device (NAS-00) to the slave NAS device (NAS-01), the NAS-01 becomes the master NAS device. Therefore, NAS-01 becomes the device that accepts access requests from the client terminal 103 and transfers these requests to the slave NAS devices (NAS-02 to NAS-05), and consequently, in the slave NAS devices (NAS-02 to NAS-05), the NAS name set as the access request transfer source, which is recorded in the access log, is set to a name indicating NAS-01. In this case, the schedule change monitoring sub-program 213 identifies the NAS-01 as the NAS device having a valid GNS definition (for example, the NAS device identified by the most recently recorded NAS name), on the basis of the access log in the slave NAS device. Therefore, as shown in FIG. 7B, after a fail-over from NAS-00 to NAS-01, the slave NAS devices (NAS-02 to NAS-05) acquire the schedule information 141 from the NAS-01.

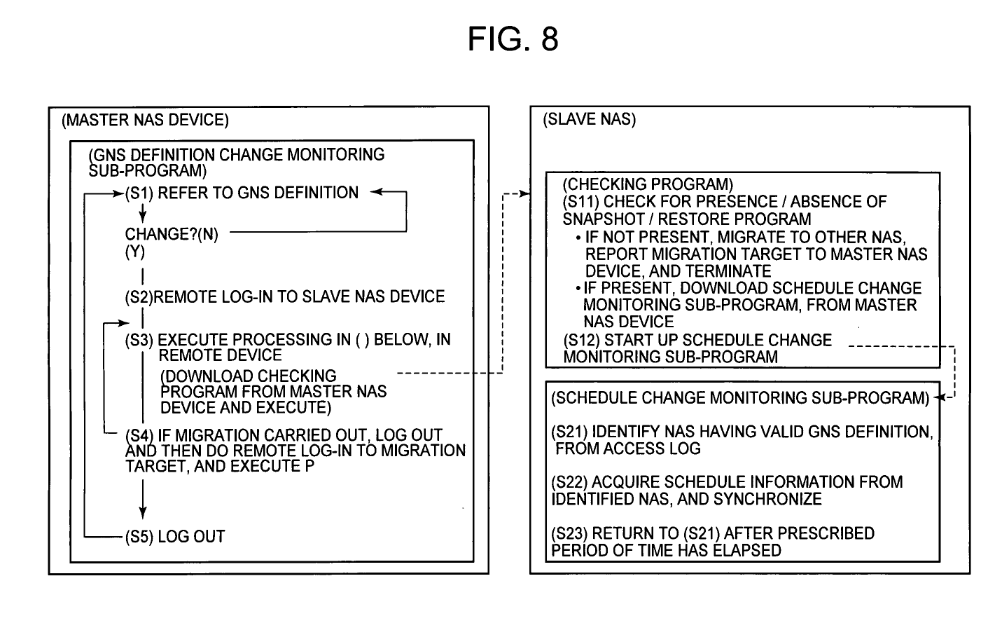

The foregoing gives an overview of one example of one process carried out in the present embodiment. Below, a sequence of processing executed respectively by the GNS definition change monitoring sub-program 203, the checking program 211 and the schedule change monitoring sub-program 213, are described in overview, with reference to FIG. 8.

The GNS definition change monitoring sub-program 203 refers to the GNS definition information 108 and judges whether or not there has been a change in the GNS definition information (step S1). If there is no change, then the GNS definition change monitoring sub-program 203 executes the step S1 again, after a prescribed period of time.

If there is a change, then the GNS definition change monitoring sub-program 203 performs a remote log-in to the NAS associated with the change in the GNS definition information 108 (for example, a slave NAS added to the GNS system) (step S2). The GNS definition change monitoring sub-program 203 downloads the checking program 211 to the slave NAS, from the master NAS device, and executes the checking program 211 (step S3).

Thereupon, the GNS definition change monitoring sub-program 203 logs out from the slave NAS device (step S5). If the GNS definition change monitoring sub-program 203 has received migration target information from the slave NAS device in response to the step S3, then it logs out from the slave NAS device and performs a remote log-in to the slave NAS device forming the migration target indicated by the received migration target information, and then executes step S3 described above.

The checking program 211, which has been downloaded from the master NAS device to the slave NAS device and executed in the slave NAS device, checks whether or not the snapshot/restore program 207B is present in that slave NAS device (step S11). If it is not present, then the checking program 211 migrates the file system mounted on this slave NAS device to another NAS device, reports the migration target to the master NAS device, and then terminates. If, on the other hand, the snapshot/restore program 207B is present, then the checking program 211 downloads the schedule change monitoring sub-program 213 from the master NAS device. Thereupon, the checking program 211 starts up the schedule change monitoring sub-program 213 (step S11).

The schedule change monitoring sub-program 213 started up in this way identifies the NAS device having valid GNS definition information, from the access log in the slave NAS device (step S21). The schedule change monitoring sub-program 213 then acquires schedule information 141 from the identified NAS device, and stores this information in the slave storage extent (step S22). In other words, the snapshot acquisition timing is synchronized with the snapshot acquisition timing in the master NAS device. The schedule change monitoring sub-program 213 executes the step S21 again after a prescribed time period has elapsed since step S22.

Below, the details of the processes carried out respectively by the GNS definition change monitoring sub-program 203, the checking program 211 and the schedule change monitoring sub-program 213, will be described.

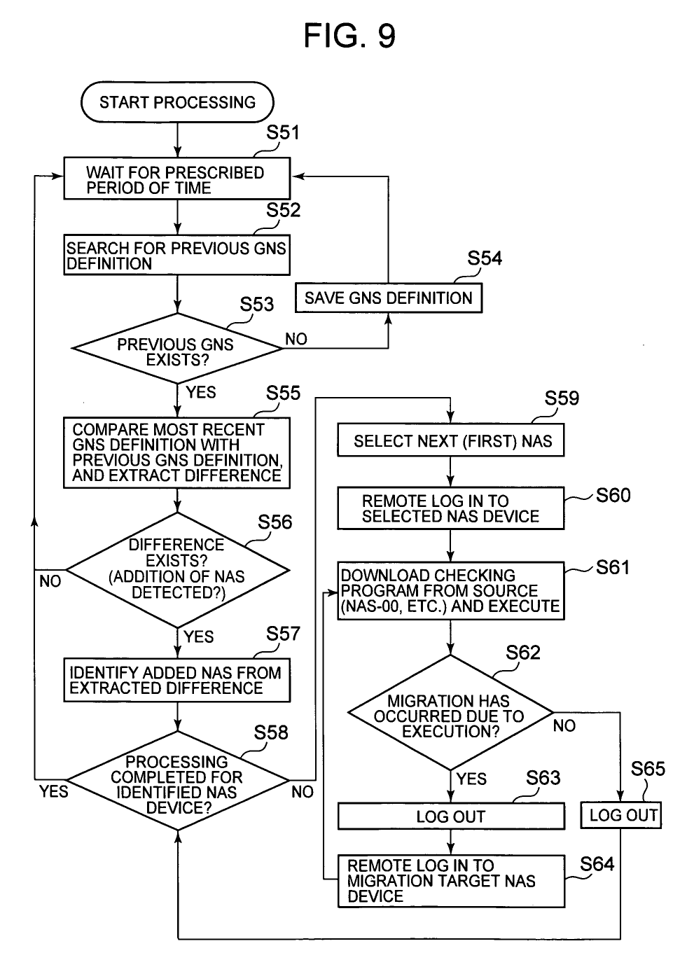

FIG. 9 shows a flowchart of processing executed by the GNS definition change monitoring sub-program 203. In the description given below, it is supposed that the most recent GNS definition information 108 is stored in one particular storage extent managed by the master NAS device (hereinafter, called storage extent A), and the GNS definition information 108 referred to by the GNS definition change monitoring sub-program 203 on the immediately previous occasion (hereinafter, called the immediately previous GNS definition information 108) is stored in another storage extent managed by the master NAS device (hereinafter, called storage extent B).

After starting up, the GNS definition change monitoring sub-program 203 waits for a prescribed period of time (step S51), and then searches for the immediately previous GNS definition information 108 from the storage extent B (step S52). If the immediately previous GNS definition information 108 is found (YES at step S53), then the procedure advances to step S55. If, on the other hand, the immediately previous GNS definition information 108 is not found (NO at step S53), then the GNS definition change monitoring sub-program 203 saves the most recent GNS definition information 108 stored in the storage extent A, to the storage extent B, as the immediately previous GNS definition information 108 (step S54). Thereupon, the procedure returns to step S51.

At step S55, the GNS definition change monitoring sub-program 203 compares the most recent GNS definition information 108 with the immediately previous GNS definition information 108, and extracts the difference between these sets of information. If this difference is a difference corresponding to the addition of a NAS device as an element of the GNS system (more specifically, a set of information elements including a new NAS name) (YES at step S56), then the procedure advances to step S57, whereas if the difference is not of this kind, then the procedure returns to step S51.

At step S57, the GNS definition change monitoring sub-program 203 identifies one or more NAS name contained in the extracted difference, and executes the processing in step S59 to step S65 in respect of each of the NAS devices corresponding to the respective NAS names (when step S59 to step S65 have been completed for all of the identified NAS devices and the verdict is YES at step S58, then the procedure returns to step S51, whereas if there is a NAS device that has not yet been processed, then step S59 to step S65 are carried out).

At step S59, the GNS definition change monitoring sub-program 203 selects, from the one or more NAS names thus identified, a NAS name which has not yet been selected at step S59.

The GNS definition change monitoring sub-program 203 performs a remote log-in to the NAS device identified by the selected NAS name (step S60). Thereupon, the GNS definition change monitoring sub-program 203 downloads the checking program 211, to the NAS device forming the remote log-in target, and executes the checking program 211 in that device (step S61).

If a migration occurs as a result of executing the checking program 211, in other words, if migration target information is received from the NAS device forming the remote log-in target (YES at step S62), then the GNS definition change monitoring sub-program 203 logs out from the NAS device which is the current log-in target (step S63), performs a remote log in to the migration destination NAS identified from the migration target information (step S64), and then returns to step S61. If, on the other hand, a migration has not occurred as a result of executing the checking program 211 (NO at step S62), then the GNS definition change monitoring sub-program 203 logs out from the NAS device forming the current log-in target (step S65) and then returns to step S58.

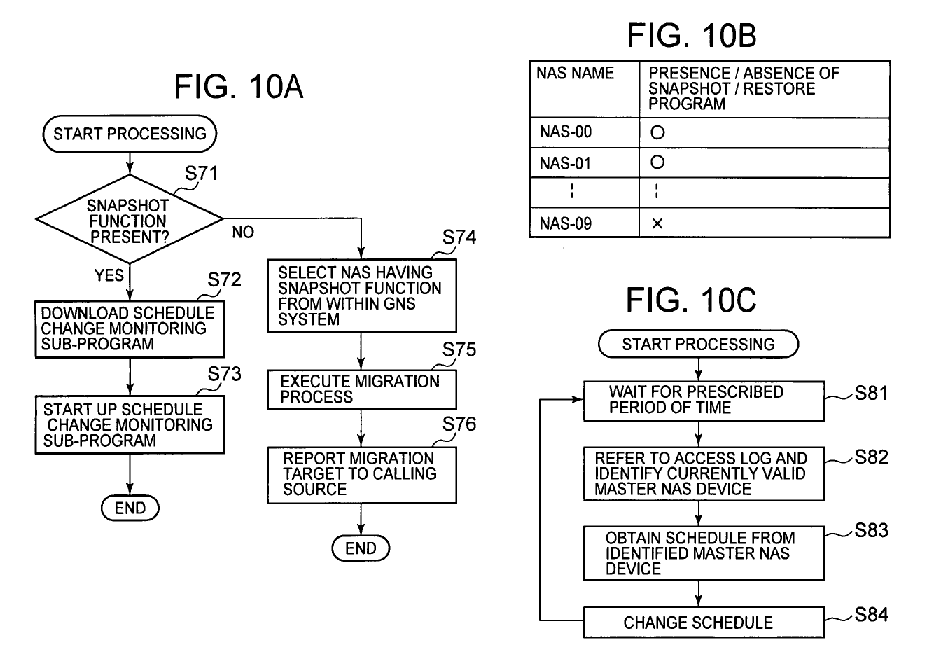

FIG. 10A shows a flowchart of processing executed by the checking program 211.

The checking program 211 is started up by a command from the GNS definition change monitoring sub-program 203. In a slave NAS device, the checking program 211 judges whether or not there is a snapshot/restore program 207B in that slave NAS device (step S71). If it is judged that the snapshot/restore program 207B is present, then the procedure advances to step S72, and if it is not present, then the procedure advances to step S74.

At step S72, the checking program 211 downloads the schedule change monitoring sub-program from the master NAS device which has the GNS definition change monitoring sub-program 203 which is source of the call. At step S73, the checking program 211 starts up the downloaded schedule change monitoring sub-program 213.

At step S74, the checking program 211 selects a NAS device which has the snapshot/restore program 207B (for example, a slave NAS device), from the GNS system. More specifically, for example, the management table shown in FIG. 10B (a table which records a NAS name, and the presence or absence of a snapshot/restore program, for each of the NAS devices which constitute the GNS system) is held by all of the NAS devices constituting the GNS system, and the checking program 211 is able to select a NAS device having the snapshot/restore program, on the basis of this management table. Alternatively, for example, an information element representing the presence or absence of a snapshot/restore program is associated with each NAS name, in the GNS definition information 108, the checking program 211 makes an enquiry to the master NAS device in respect of a NAS device having the snapshot/restore program, the master NAS device identifies a NAS device having the snapshot/restore program, on the basis of the GNS definition information 108, and sends the NAS name of that NAS device in reply to the checking program 211, and the NAS device corresponding to the NAS name indicated in the reply becomes the selected NAS device described above.

At step S75, the checking program 211 migrates the file system mounted on the slave NAS device executing the checking program 211, to the NAS device selected at step S74. The migration of the file system will be described with respect to an example where the file system (FS2) of the slave NAS device (NAS-02) is migrated to the file system (FS3) of the slave NAS device (NAS-03). In the slave NAS device (NAS-02), the checking program 211 reads the file system (FS2), via the file system program 205B (more specifically, for example, it reads out all of the objects contained in the file system (FS2)), transfers that file system (FS2) to the slave NAS device (NAS-03), and instructs mounting and sharing of the file system (FS2). The slave NAS device (NAS-03) stores the file system (FS2) which has been transferred to it, in the logical volume under its own management, by means of the file system program 205B, and it mounts and shares that file system (FS2). By this means, the migration of the file system (FS2) is completed. Alternatively, instead of the foregoing, for example, if the plurality of NAS devices 109 and the storage system 111 are connected to a communications network (for example, a SAN), then it is possible to migrate the file system (FS2) from the slave NAS device (NAS-02) to the slave NAS device (NAS-03), by means of the checking program 211 unmounting the file system (FS2) in the file system program 205B of the slave NAS device (NAS-02) and then mounting that file system (FS2) in the file system program 205B of the slave NAS device (NAS-03).

At step S76, the checking program 211 reports the migration target information (in the foregoing example, information representing that the file system (FS2) has been migrated to the NAS (NAS-03)), to the GNS definition change monitoring sub-program 203 which was the source of the call.

FIG. 10C shows a flowchart of processing executed by the schedule change monitoring sub-program 213.

After waiting for a prescribed period of time (step S81), the schedule change monitoring sub-program 213 refers to the access log and identifies the currently valid master NAS device (namely, a NAS having GNS definition information 108, which assigns access requests) (step S82). The schedule change monitoring sub-program 213 acquires the most recent schedule information 141 (namely, the schedule information 141 currently stored in the master storage extent) from the master NAS device (step S83), and it writes the schedule information 141 thus acquired over the schedule information 141 stored in the slave storage extent (step S84). Thereupon, the procedure returns to step S81. By this means, the snapshot acquisition timing of the slave NAS device is synchronized with that of the master NAS device.

In order that a client terminal 103 can use a snapshot acquired at a timing that is synchronized between the NAS devices constituting the GNS, it is necessary to restore the snapshot, more specifically, to mount the created snapshot (file system). Below, the mounting of a snapshot is described.

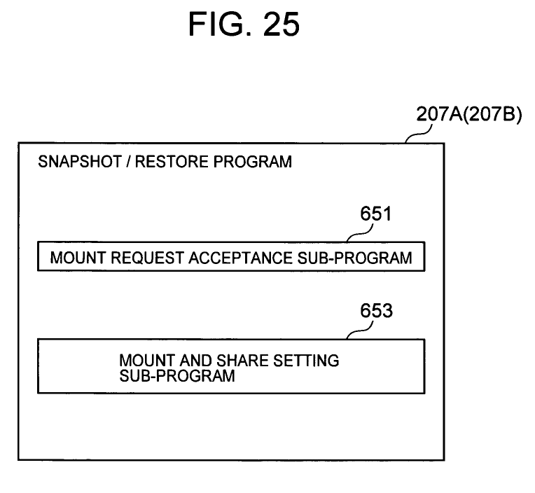

FIG. 25 shows sub-programs relating to the mounting of a snapshot, in the snapshot/restore program 207A (207B).

These sub-programs comprise a mount request acceptance sub-program 651 and a mount and share setting sub-program 653. The mount request acceptance sub-program 651 is executed in the master NAS device, and the mount and share setting sub-program 653 is executed in slave NAS device. Therefore, the snapshot/restore program 207A needs to comprise, at the least, the mount request acceptance sub-program 651, and the snapshot/restore program 207B needs to comprise, at the least, the mount and share setting sub-program 653.

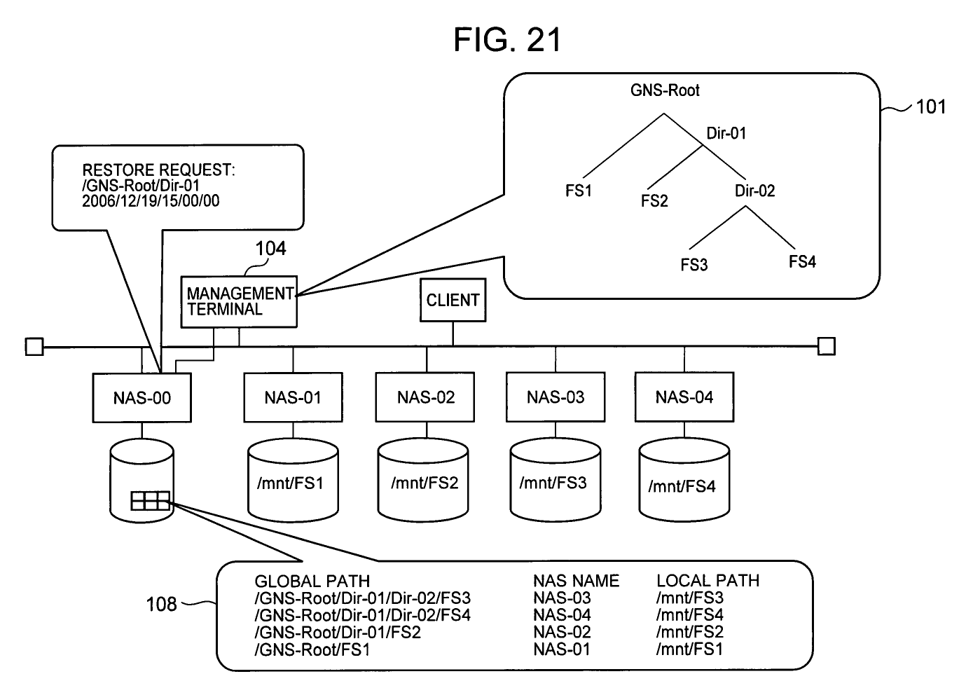

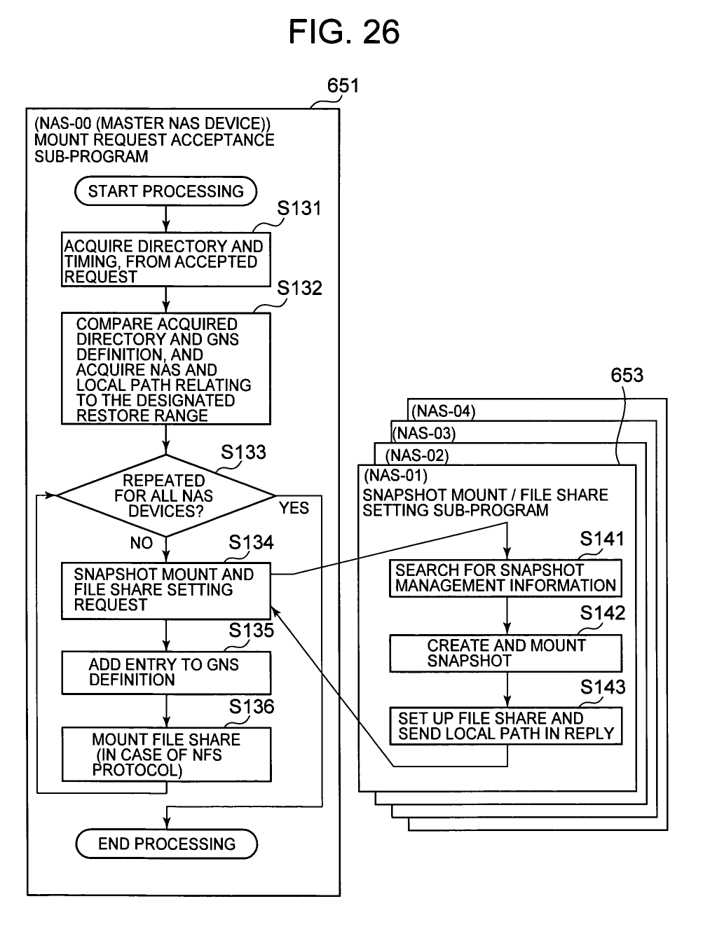

FIG. 26 shows a sequence of processing executed in the mount request acceptance sub-program 651, and a sequence of processing executed in the mount and share setting sub-program 653. Below, the processing sequence until the snapshot has been mounted is described here principally with respect to FIG. 26, with additional reference to FIG. 21 to FIG. 24.

At step S131, as shown in FIG. 21, in the master NAS device (NAS-00), the mount request acceptance sub-program 651 accepts a restore request (mount request) for the snapshot, from the management terminal 104. The restore request contains a directory point defined in the GNS (for example, a path from the head of the GNS tree to a desired tree node., such as “/GNS-Root/Dir-01”), and information indicating the snapshot acquisition timing (for example, “2006/12/19/15/00/00”) (this information is called “acquisition timing information” below). The mount request acceptance sub-program 651 acquires the directory point and the acquisition timing information on the basis of the received restore request.

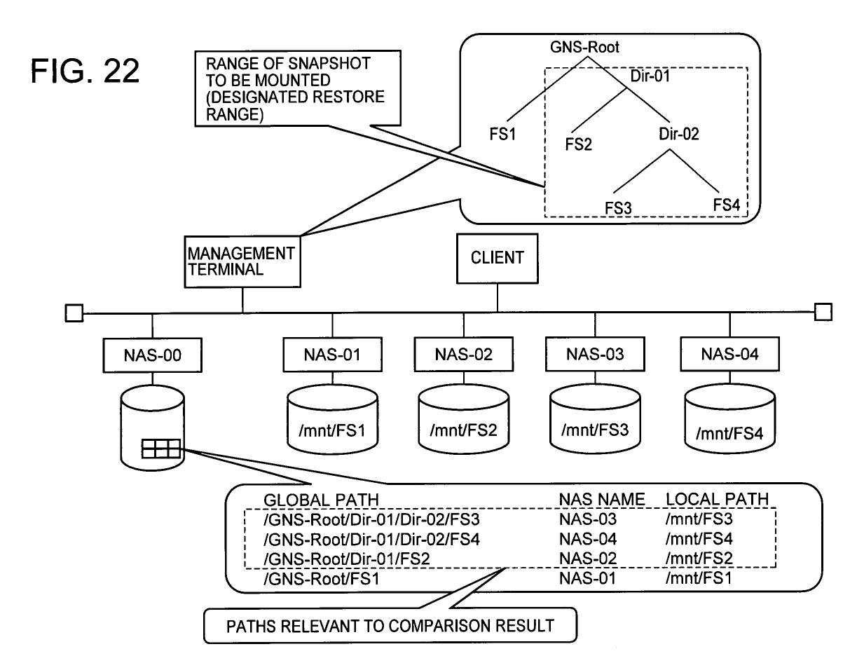

At step S132, as shown in FIG. 22, the mount request acceptance sub-program 651 identifies the designated restore range, by comparing the acquired directory point with the most recent GNS definition information 108. The designated restore range means the portion (tree range) from the tree node (apex) indicated by the directory point, to the final tree node. The mount request acceptance sub-program 651 identifies the NAS name and the local path corresponding to the global path belonging to the designated restore range (the global path passing through the directory point).

The processing in step S134 to step S136 is carried out for all of the slave NAS devices (NAS-01 to NAS-04) corresponding to the one or more NAS names thus identified (step S133). Below, the slave NAS device (NAS-01) is taken as an example.

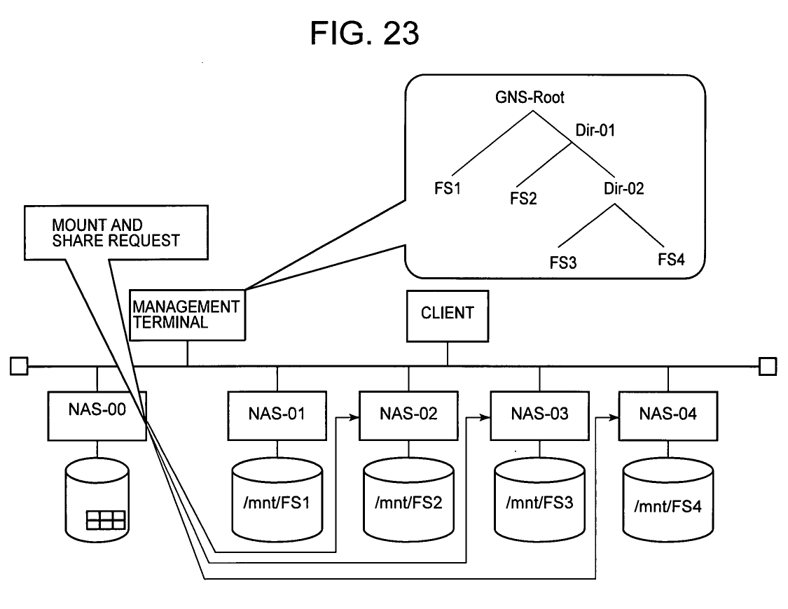

At step S134, as shown in FIG. 23, the mount request acceptance sub-program 651 sends a request to mount a snapshot and to set up file sharing (hereinafter, this is called a “mount and share request”), to the mount and share setting sub-program 653 of the identified slave NAS device (NAS-01). The mount and share request includes the acquisition timing information contained in the restore request as described above. In response to receiving this mount and share request, the mount and share setting program 653 of the slave NAS device (NAS-01) executes step S141 to step S143.

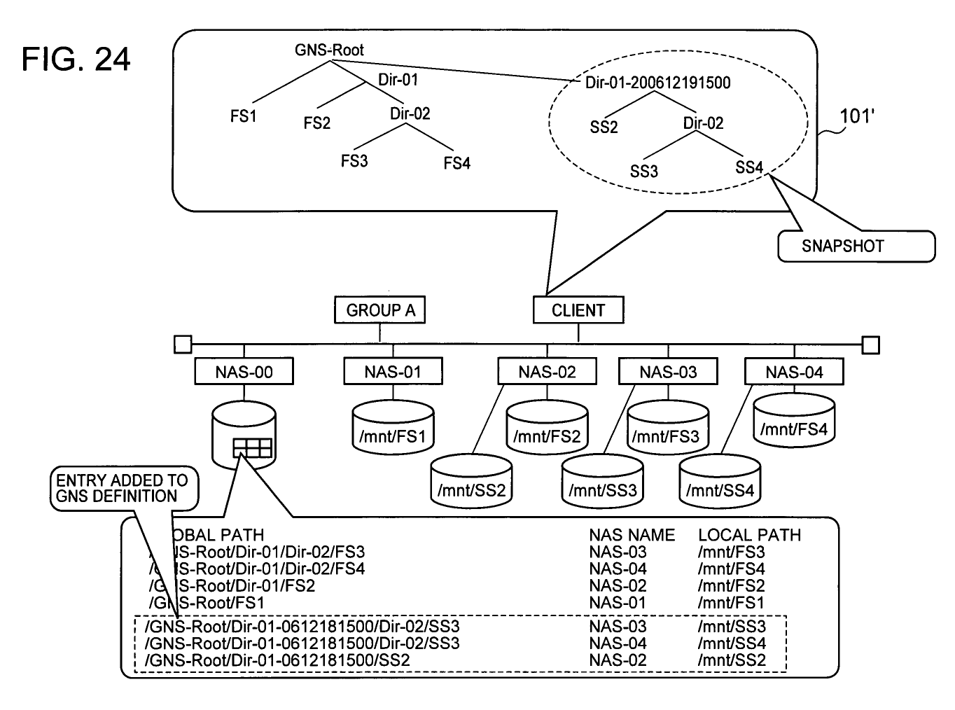

At step S141, as shown in FIG. 24, the mount and share setting sub-program 653 acquires the acquisition timing information from the received mount and share request, and searches for snapshot management information associated with the snapshot acquisition timing indicated by that acquisition timing information.

At step S142, using the snapshot management information found by this search, the mount and share setting sub-program 653 creates a snapshot (file system) for that snapshot acquisition timing and mounts the created snapshot on the file system program 205B.

At step S143, the mount and share request setting sub-program 653 shares the mounted snapshot (file system) (by setting up file sharing), and sends the local path to that snapshot, in reply, to the master NAS device (NAS-00). By this means, step S135 to step S136 are executed in the master NAS device (NAS-00).

At step S135, as shown in FIG. 24, the mount request acceptance sub-program 651 adds an entry (namely, a set of information elements including a global path and a local path) indicating a snapshot of the designated restore range stated above, to the most recent GNS definition information 108. Below, the file system in the designated restore range is represented as “FS”, and the file system in the snapshot of the designated restore range is represented as “SS”. For example, the mount request acceptance sub-program 651 adds a snapshot of the designated restore range, to a particular position on the GNS (for example, directly under the “GNS-Root”, which is the root directory (head tree node)). The mount request acceptance sub-program 651 adds a set of information elements relating to the file system in the designated restore range (for example, FS2), including the global path to the corresponding file system (for example, SS2), the local path to that file system, and the NAS name of the NAS forming the notification source of the local path (for example, NAS-02), to the most recent GNS definition information 108.

On the basis of the GNS definition information 108 to which this set of information elements has been added, it becomes possible to present a GNS 101′ including the snapshot of the designated restore range, such as that shown in FIG. 24, to the client terminal 103, and the client terminal 103 is thereby able to access the file systems (SS2 to SS4) in the snapshot in this GNS 101′. In the case of a NFS protocol, after step S135, a process for mounting file sharing (for example, a processing for mounting the GNS) is carried out in step S136.

The foregoing description related to a first embodiment of the present invention.

In this first embodiment, for example, the GNS may be presented by two or more NAS devices (for example, all of the NAS devices) of the plurality of NAS devices constituting the GNS system. In this way, it becomes possible to avoid the concentration of access requests from client terminals in one particular NAS device. In this case, the master NAS device can be the NAS device which is issuing source of the schedule information, and the slave NAS devices can be the NAS devices which receive this schedule information from the master NAS device.

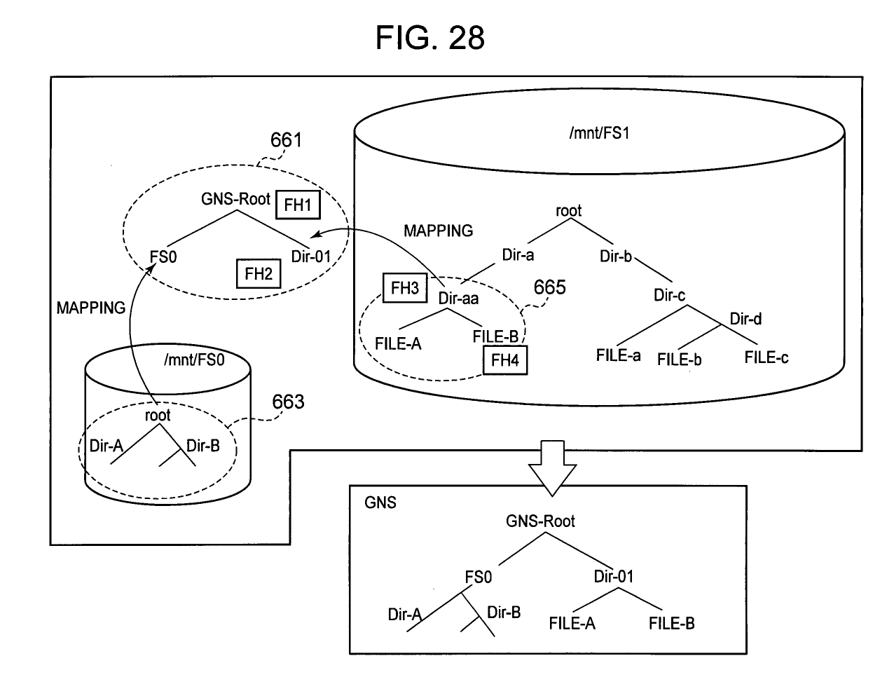

Furthermore, in the first embodiment, more specifically, it is possible to process access requests which specify an object ID (for example, a file handle), by means of an NFS protocol. A specific example of an access request using a global path, and variations of the GNS, are described now with reference to FIG. 28.

For example, in the master NAS device, a pseudo file system 661 is prepared, and one GNS can be constructed by mapping the local shared range (the shared range in one NAS device) to a name in this pseudo file system (a virtual file system forming a basis for creating a GNS). The shared range is the logical publication unit in which objects are presented to a client. The shared range may be all or a portion of the local file system. In the example in FIG. 28, the shared ranges are the shared range 663, which is the whole of the file system (FSO) mounted on the master NAS device (NAS-00), and the shared range 665, which a portion of the file system (FS1) mounted on the slave NAS device (NAS-01). The GNS shown in FIG. 28 is constructed by mapping the name “root” at the apex of the shared range 663 to the name “FS0” in the pseudo file system 661, and by mapping the name “Dir-aa” at the apex of the share range 665 to the name “Dir-01” in the pseudo file system 661.

In an NFS protocol, a client terminal performs access via an application interface, such as a remote procedure call (RPC), by using an object ID in order to identify an object, such as a file. For example, in the GNS in FIG. 28, the following processing is carried out, for instance, when the client terminal 103 accesses an object corresponding to the name “File-B”, using the NFS protocol. The client terminal 103 sends a request specifying a first access path to the object “File-B”, and on the basis of the corresponding response from the master NAS device (NAS-00), it initially acquires the object ID (FH1) of the accessible object “GNS-Root”. Furthermore, with respect to the object “Dir-01” located below the object “GNS-Root” for which the object ID (FH1) has already been acquired, the client terminal 103 acquires the object ID (FH1) already acquired, and an object ID (FH2) corresponding to the object “Dir-01”, which is determined from the response to a request specifying the object “Dir-01” under FH1. By repeating interaction of this kind, finally, the client terminal 103 can acquire the object ID (FH4) corresponding to the object “File-B”. Thereupon, if the client terminal 103 sends an access request specifying the object ID (FH4) to the master NAS device (NAS-00), then the master NAS device (NAS-00) sends an access request for accessing the object “File-B” inside the file system (FS1) of the slave NAS device (NAS-01), which corresponds to the object ID (FH4) contained in the access request from the client terminal 103, to the slave NAS device (NAS-01).

According to the first embodiment described above, the schedule information set in the master NAS device is reflected in that master NAS device and all of the other slave NAS devices which constitute the GNS system. By this means, it is possible to synchronize the snapshot acquisition timings in all of the NAS devices which constitute the GNS system.

Furthermore, according to the first embodiment, the GNS definition information 108 used by the master NAS device to present the GNS is used effectively in order to reflect the schedule information. For example, the addition of a new NAS device forming an element of the GNS system is determined from a change in the GNS definition information 108, and the schedule information is sent to the added NAS device identified on the basis of the changed GNS definition information 108.

Furthermore, according to the first embodiment, before the schedule information is sent from the master NAS device to a slave NAS device, the master NAS device sends a checking program for judging the presence or absence of an snapshot/restore program, to the slave NAS device, executes the program, and sends the schedule information to the slave NAS device if an snapshot/restore program is present in the slave NAS device. If, on the other hand, there is no snapshot/restore program, then the checking program migrates the file system from the NAS device which does not have a snapshot/restore program, to a NAS device which does have this program, and the master NAS device then sends the schedule information to the NAS device forming the migration target. By this means, since a snapshot is always acquired, in all of the file systems represented by the GNS, then it is possible accurately to list the designated restore range at a particular point of time in the past.

### Second Embodiment

Next, a second embodiment of the present invention will be described. The following description will focus on differences with respect to the first embodiment, and points which are common with the first embodiment are either omitted or are explained briefly.

In this second embodiment, it is possible to synchronize the snapshot acquisition timings with respect to the correlated objects in the GNS.

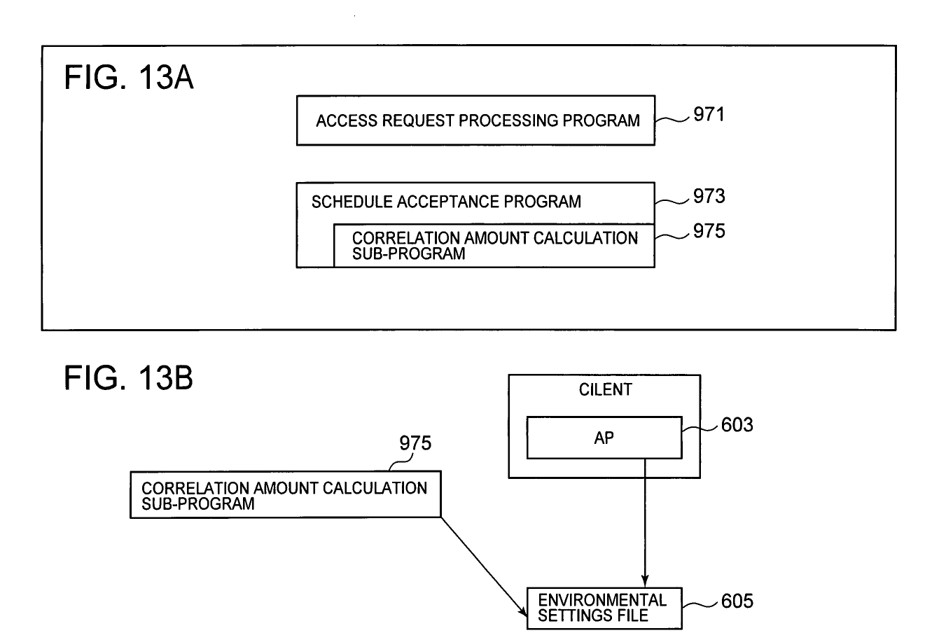

For example, as shown in FIG. 13A, the master NAS device comprises: an access request processing program 971 which transfers an access request from a client terminal 103 to a slave NAS device, and records prescribed types of information in the transfer log, accordingly; and a schedule acceptance program 973 which accepts schedule information relating to one or more object desired by the administrator. The schedule acceptance program 973 comprises a correlation amount calculation sub-program 975 which calculates the amount of correlation between the respective objects of the identified plurality of objects.

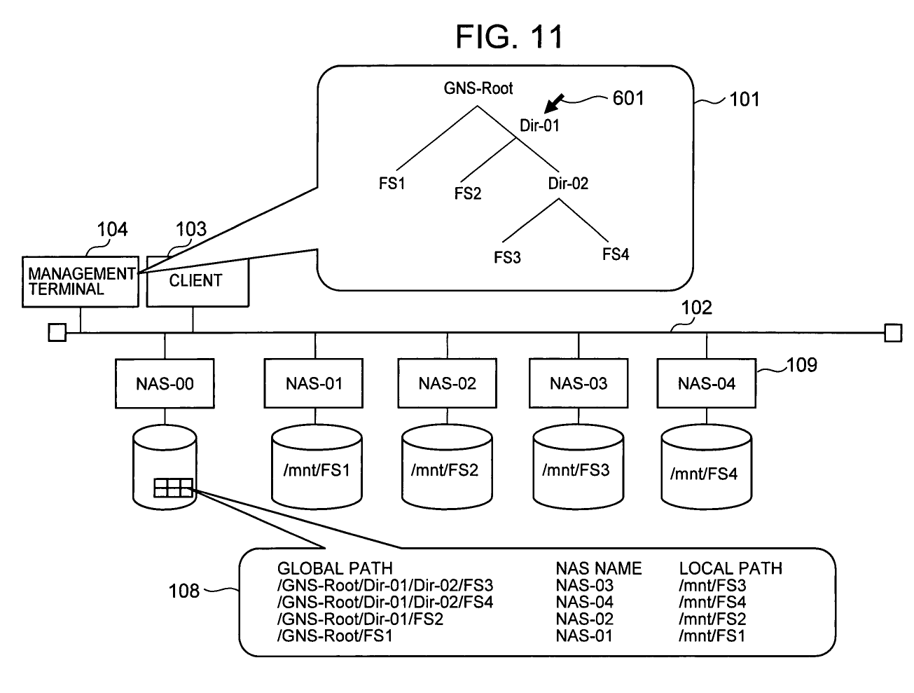

As shown in FIG. 11, in response to the request from the management terminal 104, the schedule acceptance program 973 of the master NAS device (NAS-00) displays a view showing the GNS 101 (hereinafter, called the “GNS view”), on the basis of the GNS definition information 108, and accepts a directory point desired by the administrator. Here, by operating an input device (for example, a mouse) of the management terminal 104, the tree node “Dir-01” is designated with the cursor 601 on the GNS view. In this case, the schedule acceptance program 973 identifies FS2, FS3 and FS4, as the object names situated below the designated tree node “Dir-01”, from the GNS definition information 108.

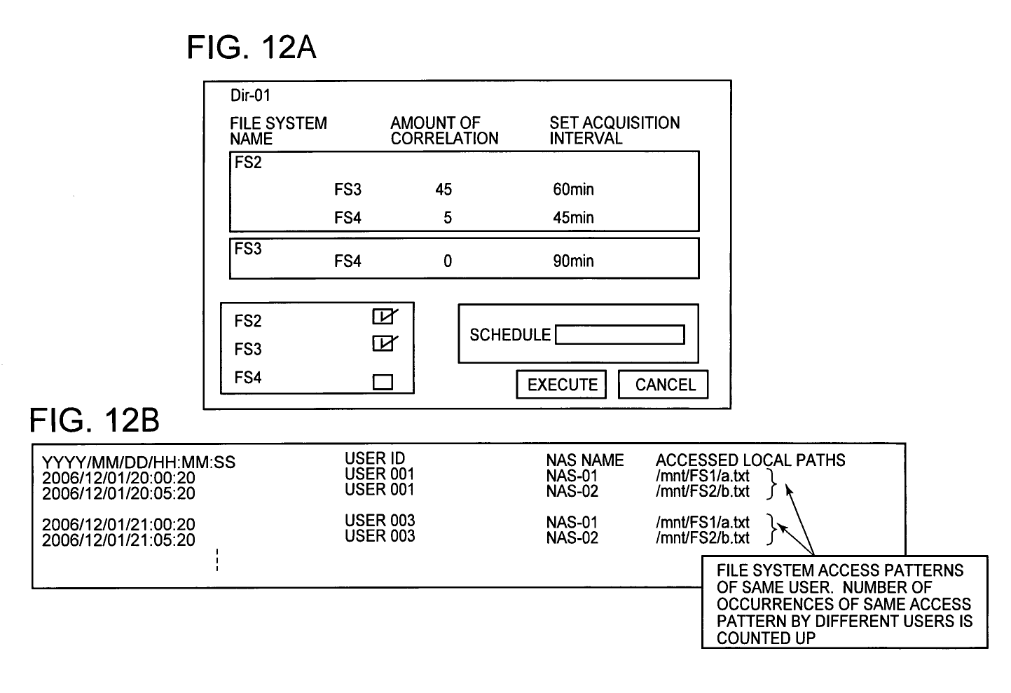

Here, the correlation amount calculation sub-program 975 of the schedule acceptance program 973 calculates the amounts of correlation between the objects corresponding to the identified object names (FS2, FS3 and FS4). The schedule acceptance program 973 creates the schedule acceptance screen (GUI) shown in FIG. 12A, on the basis of the respective correlation amounts calculated above, and it presents this schedule acceptance screen to the management terminal 104. This schedule acceptance screen (GUI) shows that the amount of correlation between the file system (FS2) and the file system (FS3) is “45”, the amount of correlation between the file system (FS2) and the file system (FS4) is “5”, and the amount of correlation between the file system (FS3) and the file system (FS4) is “0”, and this screen can be used to set the type of schedule to be applied to each of the file systems (FS2, FS3 and FS4). On this schedule acceptance screen, for example, the administrator specifies file systems (for example, FS2 and FS3), inputs common schedule information for these file systems, and then presses the “Execute” button. In response to the pressing of the “Execute” button, the schedule acceptance program 973 associates the input schedule information with the file system names, “FS2” and “FS3”, in the master storage extent.

In this case, in the GNS system in FIG. 11, for example, the GNS definition change monitoring sub-program 203 does not send the checking program 211 to the slave NAS device (NAS-04) having FS4, but it does send the checking program 211 to the slave NAS device (NAS-02) having FS2 and the slave NAS device (NAS-03) having FS3; (furthermore, even if the file system (FS5) of a new slave NAS device (NAS-05) is added, the GNS definition change monitoring sub-program 203 does not send the checking program 211 to the slave NAS device (NAS-05) unless it is added under the tree node “Dir-01”). Therefore, the schedule information stored in the master storage extent is downloaded only to the slave NAS devices (NAS-02 and NAS-03) of the slave NAS devices (NAS-02 to NAS-04). In this case, the file system names “FS2” and “FS3” associated with these NAS devices are also downloaded and stored in the slave storage extents, in addition to the schedule information: In the slave NAS devices (NAS-02 and NAS-03), the snapshot/restore program 205B acquires a snapshot of the file system corresponding to the file system name stored in the slave storage extent, at the timing according to the schedule information associated with that file system name in the slave storage extent. In other words, in the GNS system in FIG. 11, it is possible to synchronize the snapshot acquisition timing in the master NAS device (NAS-00), only with respect to the portion of the GNS designated by the administrator.

Furthermore, the GNS definition change monitoring sub-program 203 is able to manage the directory points designated by the administrator. If the addition of a NAS device is detected on the basis of the GNS definition information 108, and if the object has been added under the directory point, then the checking program 211 is sent to the added NAS device, but if the object has not been added under the directory point, then the checking program 211 is not sent to the added NAS device.

Here, the following three calculation methods, for example, can be envisaged for calculating the amount of correlation.

The first calculation method is one which uses the transfer log that is updated by the access request processing program 971. FIG. 12B shows one example of the transfer log. The access request processing program 971 records, in the transfer log, information such as the date and time at which an access request was received from a client terminal 103, the ID of the user of the client terminal 103, the NAS name of the transfer target of the access request, and the local path used to transfer the access request. The correlation amount calculation program 975 counts the number of times that the same access pattern (in this case, the same combination of a plurality of file systems used by one user) has occurred in the case of a plurality of different users (below, this is referred to as the “number of access occurrences”), and calculates an amount of correlation on the basis of this count value (for example, it calculates a higher amount of correlation, the higher this count value). More specifically, for example, in a case where there are four users who have used both file system (FS2) and file system (FS3) (in other words, the number of access occurrences is four), and there are two users who have used both file system (FS2) and file system (FS4) (in other words, the number of access occurrences is two), then the correlation amount calculation sub-program 975 calculates the amount of correlation between file system (FS2) and file system (FS3) to be a higher value than the amount of correlation between file system (FS2) and file system (FS4).

The second calculation method is a method which uses the tree structure in the GNS. The correlation amount calculation sub-program 975 calculates a correlation amount on the basis of the number of links between the tree node points (for example, it calculates a high correlation amount, the higher the number of links). More specifically, for example, in the GNS 101 shown in FIG. 11, the number of links between file system (FS3) and file system (FS4) is two, and the number of links between file system (FS2) and file system (FS3) is three. Therefore, the correlation amount calculation sub-program 975 calculates the amount of correlation between file system (FS3) and file system (FS4) to be greater than the amount of correlation between file system (FS2) and file system (FS3).

The third calculation method is a method which uses the environmental settings file 605 for the application program 603 executed by the client terminal 103 (see FIG. 13B). The environmental settings file 605 records, for example, which paths are used by the application program 603. If a plurality of file systems are identified from the plurality of paths recorded in the environmental settings file 605, then the correlation amount calculation sub-program 975 judges that there is a correlation between that plurality of file systems. The correlation amount calculation sub-program 975 is able to calculate the correlation on the basis of the number of times that there is judged to be a correlation.

The foregoing description related a second embodiment of the present invention.

### Third Embodiment

For example, in the GNS, it is possible for files which are distributed over a plurality of NAS devices to be displayed to a user exactly as if they were stored in one single directory. In a case where a plurality of files which require update are stored in respectively different NAS devices, if a user belonging to a user group creates a new file share on the GNS and moves files to this file share, then when other users of the same user group use those files, the files are moved arbitrarily, which gives rise to problems.

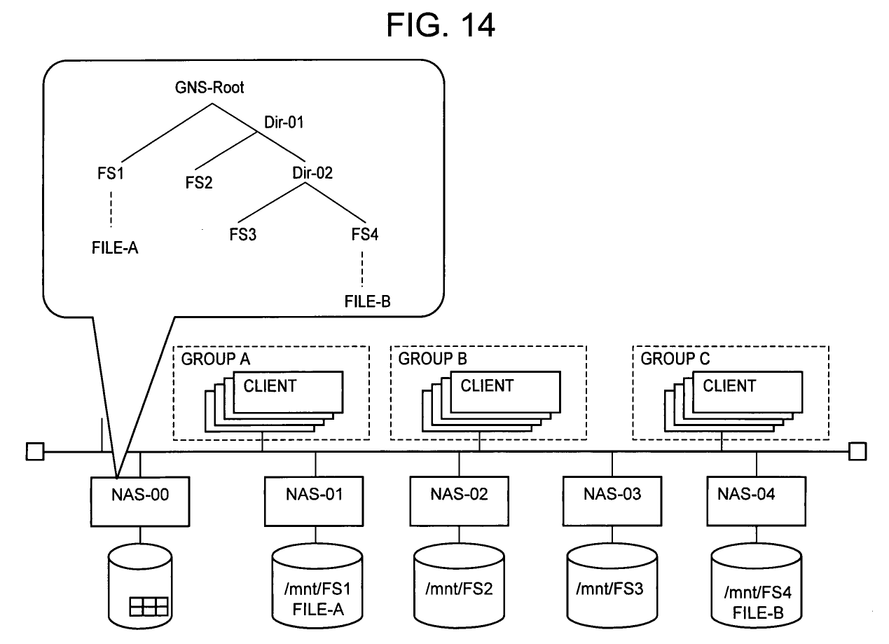

More specifically, for example, a client user (a user of the client terminal 103) belonging to a user group (Group A), as shown in FIG. 14, uses a file (File-A) stored in the file system (FS1) and a file (File-B) stored in the file system (FS4), in the course of his or her business, and therefore, it is inconvenient if these files are stored respectively in different directories. Consequently, it is preferable to store the files in one folder (directory).

However, the client user of a user group (Group B) also uses the file (File-B) stored in the file system (FS4), and therefore, if the storage location of this file is moved arbitrarily, problems will arise. In a similar fashion, the client user of a user group (Group C) also uses the file (File-A) stored in the file system (FS1), and therefore, if the storage location of this file is moved arbitrarily, problems will arise.

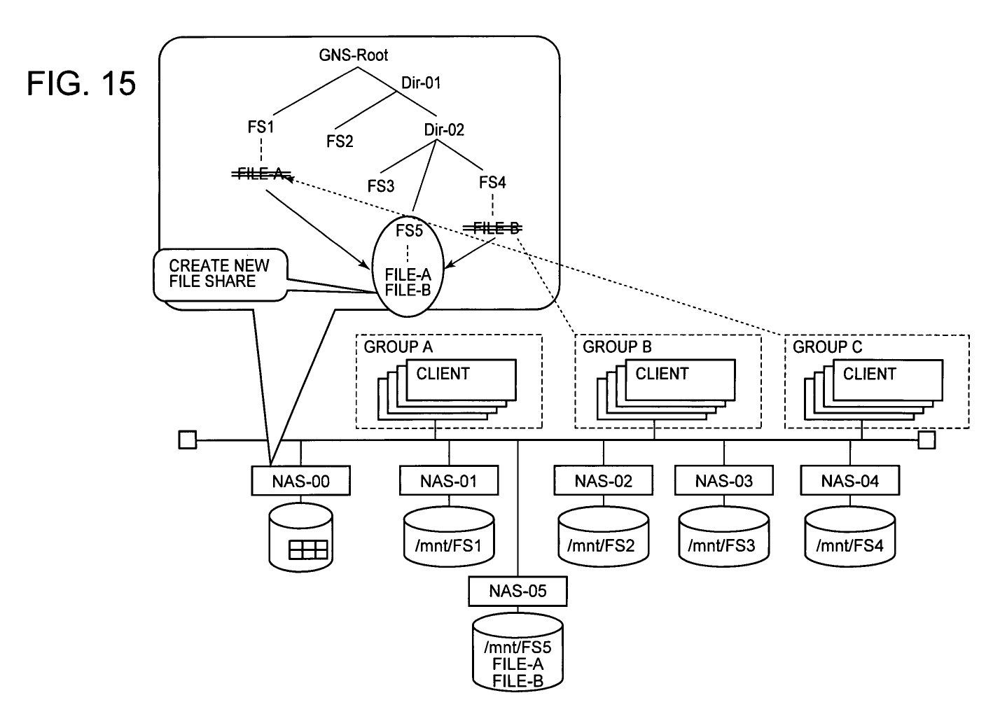

It is supposed that, in a case such as this, a new file share (shared folder) is created. For example, it is supposed that, as shown in FIG. 15, the slave NAS device (NAS-05) is added and the file system (FS5) is mounted. If the files (File-A and File-B) are moved to file system (FS5), then the files are gathered into one folder (directory) for the user client belonging to the user group (Group A), thus improving convenience for that user. However, if the client user of the user group (Group B) uses the file system (FS4), then the file (File-B) is not present, and if the client user of the user group (Group C) uses the file system (FS1), the file (File-A) is not present. Therefore, this configuration is inconvenient for these users.

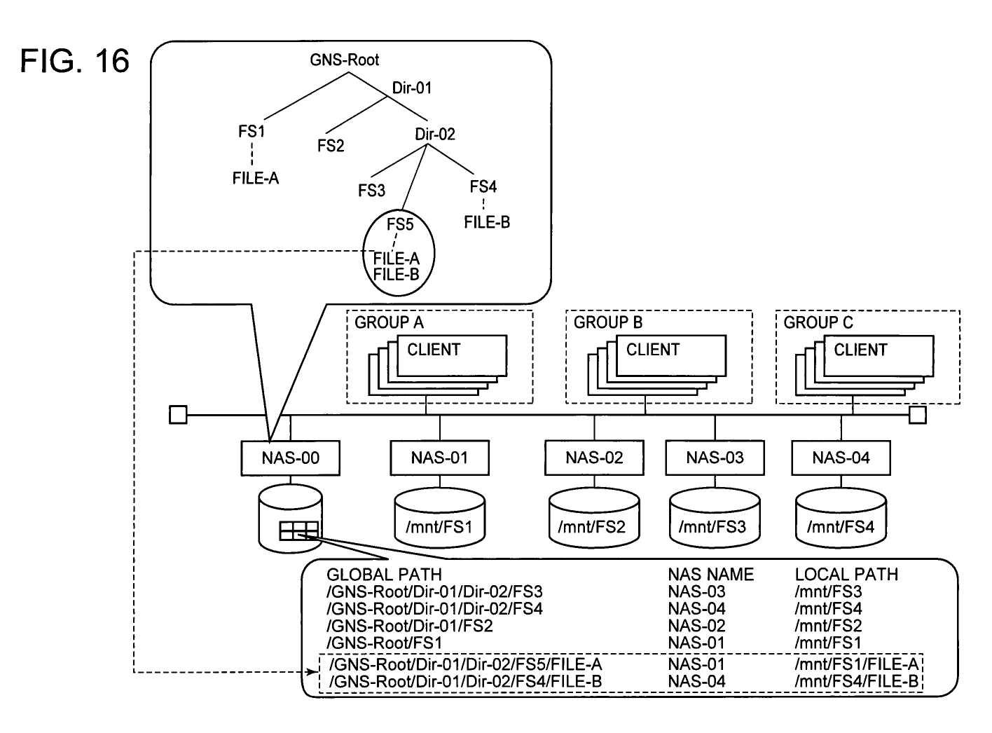

Consequently, as shown in FIG. 16, it is necessary to create a virtual file share, as required by the user groups, without migrating the files. In a file share of this kind, files distributed to a plurality of different NAS devices are stored in a virtual fashion. In other words, an object inside the virtual file share is associated with an object inside another file share, and if the object inside the virtual file share is specified, then the object inside the other file share, which is associated with that object, is presented.

More specifically, for example, as shown in FIG. 16, it is supposed that an administrator has added the two global paths and two local paths within the dotted frame, to the GNS definition information 108. The two global paths are paths which express the fact that the files (File-A and File-B) are stored in the virtual file share (FS5), and the association of the two local paths with these two global paths means that the actual entity of the file (File-A) in the virtual file share (FS5) is the file (File-A) inside file system (FS1), and the actual entity of the file (File-B) in the virtual file share (FS5) is the file (File-B) inside file system (FS4). Accordingly, since the files (File-A and File-B) are stored together in the same folder (FS5), then usability is improved for the client user belonging to Group A. Furthermore, the client user belonging to Group B is still able to refer to file (File-B), as previously, when the user accesses the folder (FS4), and the client user belonging to Group C is still able to refer to file (File-A), as previously, when the user accesses the folder (FS1).

The master NAS device (NAS-00) monitors the presence of absence of an update to the GNS definition information 108. By this means, if it is detected that the updated GNS definition information contains a local path which is the same as an added local path, with the exception of the specific portion of the path (indicating the file name, or the like), then the plurality of file systems (for example, FS1 and FS4) are identified respectively from these local paths, and these file systems can be reported to the administrator as candidates for synchronization of the snapshot acquisition timing. In other words, in the third embodiment, it is possible to identify the correlation between file systems by means of a different method to that of the second embodiment. A more specific description is given below.

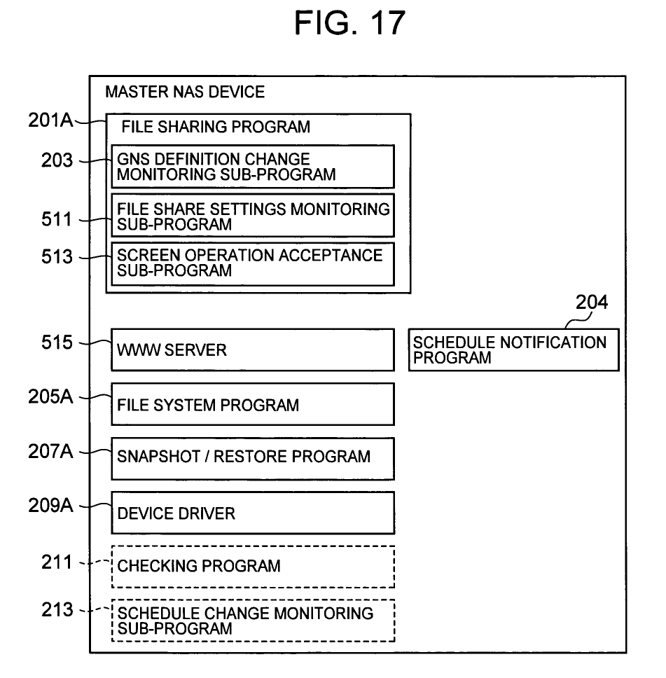

FIG. 17 shows one example of a computer program provided in the master NAS device, in this third embodiment.

The master NAS device also comprises a WWW server 515, in contrast to the first embodiment. Furthermore, the file sharing program 201A comprises a file share settings monitoring sub-program 511 and a screen operation acceptance sub-program 513.

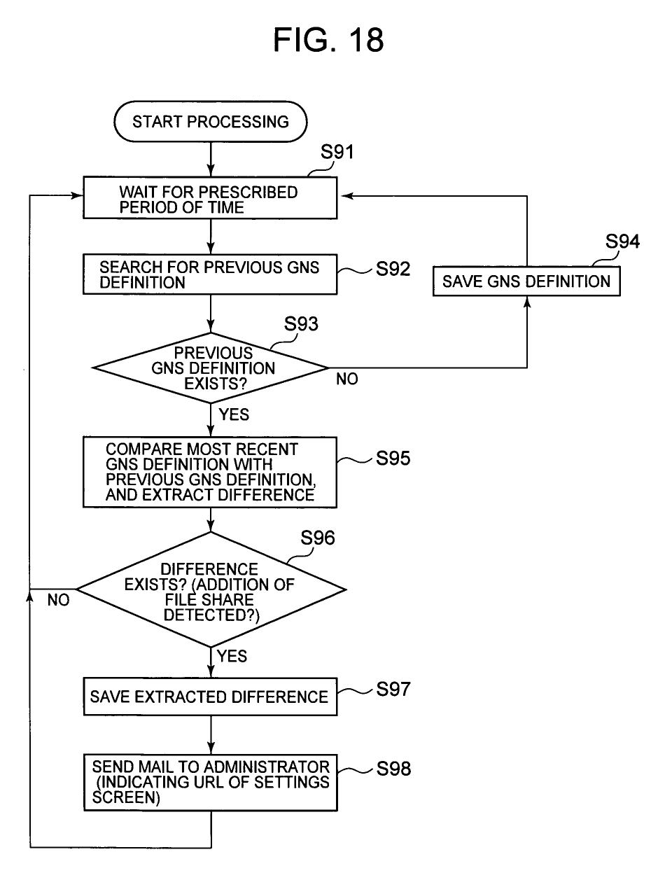

FIG. 18 shows a flowchart of processing executed by the file share settings monitoring sub-program 511.

The file share settings monitoring sub-program 511 is able to execute the step S91 to step S95, which are similar to the step S51 to step S55 in FIG. 9.

If the difference thus extracted is a difference indicating the addition of a file share, in other words, if it is a plurality of sets of information elements comprising a file system name on a global path, and different file system names on the local paths associated with that global path, then the verdict is YES at step S96, and the procedure advances to step S97, whereas if this is not the case, then the procedure returns to step S91.

At step S97, the file share settings monitoring sub-program 511 saves the extracted difference, to a prescribed storage extent managed by the master NAS device. At this stage, the file share settings monitoring sub-program 511 is able to prepare information for constructing a schedule settings screen (a Web page), as described hereinafter, on the basis of this difference.

At step S98, the file share settings monitoring sub-program 511 sends an electronic mail indicating the URL (Uniform Resource Locator) of the settings screen, to the administrator. The settings screen URL is a URL for accessing the schedule settings screen. The electronic mail address of the administrator is registered in a prescribed storage extent, and the file share settings monitoring sub-program 511 is able to identify the electronic mail address of the administrator, from this storage extent, and to send the aforementioned electronic mail to the identified electronic mail address.

In the management terminal 104, the electronic mail is displayed and if the administrator then specifies the settings screen URL, the WWW browser 515 presents information for constructing the aforementioned schedule settings screen, to the management terminal 104, and the management terminal 104 is able to construct and display a schedule settings screen, on the basis of this information.

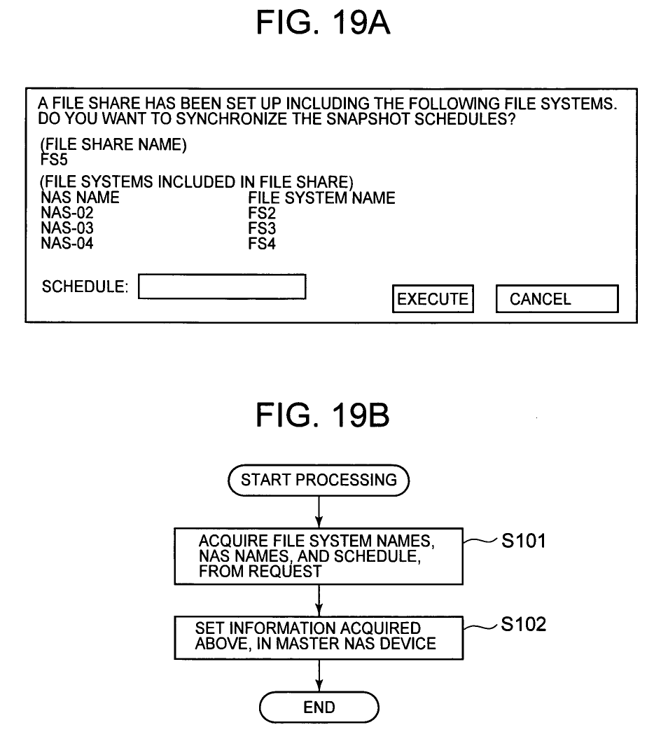

FIG. 19A shows an example of a schedule settings screen.

The schedule settings screen displays: the name of the file share identified from the definition of the addition described above, the names of the plurality of file systems where the entities identified from the definition of the addition are located, the names of the plurality of NAS devices which respectively have this plurality of file systems, and an schedule information input box for this plurality of file systems. The administrator calls up the screen operation acceptance sub-program 513 by inputting schedule information in the input box and then pressing the “Execute” button. In this case, a request containing the plurality of file system names displayed on the schedule settings screen (for example, FS1 and FS4), the plurality of NAS names (for example, NAS-01 and NAS-04), and the schedule information, is sent from the management terminal 104 to the master NAS device.

FIG. 19B shows a flowchart of processing executed by the screen operation acceptance sub-program 513.

The screen operation acceptance sub-program 513 acquires the plurality of file system names, the plurality of NAS names and the schedule information, from the request received from the management terminal 104 (step S101). The screen operation acceptance sub-program 513 then stores the plurality of NAS names (for example, NAS-01 and NAS-04), the plurality of file system names (for example, FS1 and FS4) and the schedule information, in the master storage extent. Thereby, it is possible to synchronize the snapshot acquisition timing set in the master NAS device, with respect to the FS1 of NAS-01 and the FS4 of NAS-04.

In the first embodiment, the checking program 211 is sent to all of the slave NAS devices identified on the basis of the GNS definition information 108, but in the second and third embodiments, the checking program 211 is only sent to the slave NAS devices having NAS names which are associated with the schedule information in the master storage extent.

### Fourth Embodiment

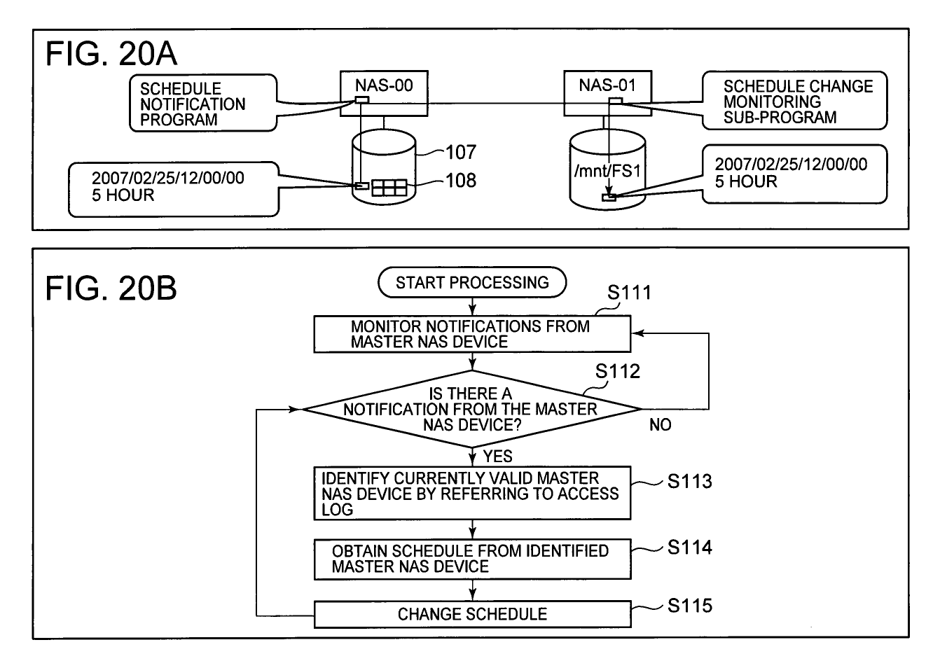

As shown in FIG. 20A, for example, the schedule notification program 204 is able to send the schedule information set in the master NAS device (NAS-00), actively, to the respective slave NAS devices (for example, NAS-01).

In this case, in the slave NAS device (NAS-01), as shown in the example in FIG. 20B, if the schedule change monitoring sub-program 213 is monitoring notifications from the master NAS device (step S111) and receives a notification relating to schedule information from the master NAS device (YES at step S112), then the schedule change monitoring sub-program 213 refers to the access log of the slave NAS device (NAS-01), identifies the currently valid master NAS device (step S113), obtains schedule information from the identified master NAS device (step S114), and overwrites the obtained schedule information to the slave storage extent (step S115).

In other words, the schedule change monitoring sub-program 213 may overwrite the schedule information reported from the master NAS device, directly, onto the slave storage extent, but as shown in step S113, it is also able to identify the currently valid master NAS device and to acquire schedule information from the master NAS device thus identified. By this means, for example, if the master NAS device carries out a fail-over to other NAS device after reporting the schedule information, then the schedule change monitoring sub-program 213 is able to acquire the schedule information from the new master NAS device forming the fail-over target.

Several preferred embodiments of the present invention were described above, but these are examples for the purpose of describing the present invention, and the scope of the present invention is not limited to these embodiments alone. The present invention may be implemented in various further modes.

What is claimed is:

1. A storage control device, which is one storage control device of a plurality of storage control devices constituting a storage virtualization system which presents a virtual name space; comprising:
a storage control device identification section which identifies two or more other storage control devices, of the plurality of storage control devices, which respectively have an object corresponding to an object name belonging to a particular range comprising all or a portion of the virtual name space, on the basis of virtualization definition information which represents respective locations, within the storage virtualization system, of the objects corresponding to the object names in the virtual name space; and
a backup timing synchronization section which sends backup timing information which indicates backup timing for the object, to the identified two or more other storage control devices.

2. The storage control device as defined in claim 1, further comprising a virtualization definition monitoring section, which monitors the presence or absence of updating of the virtualization definition information, and executes processing in accordance with a difference between the virtualization definition information before update and the virtualization definition information after update, in response to detecting the presence of an update.

3. The storage control device as defined in claim 2, further comprising a checking section, which is a computer program, wherein
when the difference includes a storage control device ID which is not present in the virtualization definition information before update but which is present in the virtualization definition information after update, then the virtualization definition monitoring section executes sending of the checking section to the other storage control device identified on the basis of the storage control device ID, as processing corresponding to the difference; and
the checking section checks whether or not the backup section is provided in the other storage control device which has received the checking section.

4. The storage control device as defined in claim 3, further comprising:
a backup timing acquisition section, which is a computer program which interacts with the backup timing synchronization section; and
a transmission section which sends the backup timing acquisition section to the other storage control device, in response to a prescribed signal from the checking section, wherein
the checking section receives the backup timing acquisition section by sending the prescribed signal, when a result of the check indicates that the backup section is provided in the other storage control device, and
the backup timing acquisition section stores backup timing information received from the backup timing synchronization section, in a storage extent managed by the other storage control device.

5. The storage control device as defined in claim 3, wherein the checking section migrates the object managed by the other storage control device, to a storage control device provided with a backup section, and sends information indicating a migration target of that object, to a transmission source of the check section, when the result of the check indicates that the backup section is not provided in the other storage control device.

6. The storage control device as defined in claim 1, further comprising:
a backup timing acquisition section, which is a computer program which interacts with the backup timing synchronization section; and
a transmission section which sends the backup timing acquisition section to the second storage control device, wherein
the backup timing acquisition section stores backup timing information received from the backup timing synchronization section, in a storage extent managed by the other storage control device executing the backup timing acquisition section.

7. The storage control device as defined in claim 6,
wherein the backup timing acquisition section requests the backup timing synchronization section to transmit backup timing information periodically or in response to detecting that the backup timing information stored in the storage extent has been updated, and
the backup timing synchronization section sends the backup timing information to the backup timing acquisition section, in response to the request from the backup timing acquisition section.

8. The storage control device as defined in claim 7, wherein the backup timing acquisition section distinguishes a currently valid storage control device on the basis of an access log held by the other storage control device executing the backup timing acquisition section, and requests the backup timing synchronization section in the distinguished storage control device to transmit backup timing information.

9. The storage control device as defined in claim 7,
wherein the backup timing synchronization section sends backup timing information, to the backup timing acquisition section, periodically or in response to detecting that the backup timing information stored in the storage extent has been updated, and
after receiving the backup timing information, the backup timing acquisition section distinguishes the currently valid storage control device on the basis of an access log held by the other storage control device executing the backup timing acquisition section, and requests the storage control device thus distinguished rather than the transmission source of the backup timing information to transmit backup timing information.

10. The storage control device as defined in claim 1, further comprising:
a checking section, which is a computer program; and
a transmission section, which sends the checking section to the other storage control device, wherein
by means of the checking section being executed in the other storage control device which has received same, the checking section checks whether or not a backup section is provided in the other storage control device, and when a result of the check indicates that the backup section is not provided in the other storage control device, then the object managed by the other storage control device executing the checking section is migrated to a storage control device that is provided with the backup section, and information expressing a migration target of the object is sent to a transmission source of the checking section.

11. The storage control device as defined in claim 1, wherein the backup timing synchronization section sends backup timing information to other storage control devices respectively having objects having a particular correlation, of the plurality of storage control devices.

12. The storage control device as defined in claim 11, further comprising:
a designation acceptance section which accepts designation, by a user, of a particular range in the virtual name space;
a degree of correlation calculation section which respectively calculates the degree of correlation between two or more objects relating to the particular range thus designated, of the plurality of objects;
a degree of correlation display section which displays the calculated degrees of correlation between the respective objects, to the user; and
a selection acceptance section which accepts the selection of objects desired by the user, of the two or more objects, wherein
the objects having the particular correlation are objects desired by the user, and
the backup timing synchronization section sends backup timing information to the other storage control devices which have the objects desired by the user.

13. The storage control device as defined in claim 12, further comprising:
an access control section which receives an access request including a first designation relating to an object name in the virtual name space from a client, and transfers an access request including a second designation for accessing an object corresponding to the first designation, to the other storage control device relating to the second designation; and
an access management section which records information relating to transfer of the access request to the other storage control device, in a transfer log, wherein
information including an ID of the user of the client and an ID of the object specified by the second designation is recorded in the transfer log, and
the degree of correlation calculation section refers to the transfer log, counts the number of different users who have used the same access pattern, and calculates the degree of correlation between objects on the basis of the number of users,
the access pattern being a combination of a plurality of objects which are used by the same user.

14. The storage control device as defined in claim 12,
wherein, in the virtual name space, a plurality of object names corresponding respectively to a plurality of objects are associated in the form of a tree, and
the degree of correlation between one object and another object is calculated on the basis of the number of name links existing between the object names corresponding to the one object and the object name corresponding to the other object.

15. The storage control device as defined in claim 12, wherein the degree of correlation calculation section calculates the degree of correlation between objects on the basis of an environmental settings file of an application program executed by the client.

16. The storage control device as defined in claim 2,
wherein the virtualization definition monitoring section identifies two or more objects on the basis of the difference, if the difference is information indicating that a virtual file associated with a file having an actual entity has been stored in a virtual shared directory, and
the objects having a particular correlation are the two or more objects thus identified.

17. The storage control device as defined in claim 1,
wherein the backup section is formed such that, when an object is backed up at the timing indicated by the received backup timing information, the backup object, which is the object that has been backed up, is stored in association with timing at which backup had been executed, and when a restore request including information indicating the backup timing is received, the backup object associated with the backup timing indicated by this information is restored, and information expressing an access target to the restored backup object is returned to the transmission source of the information indicating the backup timing,
the storage control device further comprising a restore control section, which sends a restore request including information indicating a backup timing, to the two or more other storage control devices, receives information expressing the access target to the restored backup object, in response to the request, from the two or more other storage control devices, and updates the virtualization definition information on the basis of this information, and wherein
the virtualization definition information after updating by the restore control section includes information in which an object name expressing the restored backup object is expressed in the virtual name space and in which a storage location, within the storage virtualization system, of the object corresponding to this object name is expressed.

18. The storage control device as defined in claim 1, wherein
the virtual name space is a global name space,
the virtualization definition information is information expressing definitions for presenting the global name space, the information including a plurality of sets of information each comprising a global path corresponding to an object name in the global name space, ID of the storage control device having the object corresponding to this object name, and a local path for accessing this object;
the storage control device identification section and the backup timing synchronization section are a processor which executes one or a plurality of computer programs, and wherein
the processor executes:
monitoring the presence or absence of updating of the virtualization definition information; sending a checking program to another storage control device identified by the corresponding storage control device ID, when the virtualization definition information after update includes a storage control device ID that had not been present in the virtualization definition information before update; checking whether or not a backup program is provided in the other storage control device, by means of the checking program being executed by the processor of the other storage control device; and receiving a prescribed signal from the other storage control device when a result of the check indicates that the backup program is provided in the other storage control device; sending a backup timing acquisition program to the other storage control device which is a transmission source of the prescribed signal, in response to reception of the prescribed signal; storing backup timing information received by the other storage control device by means of the backup timing acquisition program being executed by the processor of the other storage control device; and distinguishing objects having a particular correlation; identifying the storage control devices holding the distinguished objects, on the basis of the virtualization definition information; and sending backup timing information to the identified storage control devices, of the plurality of storage control devices, and wherein
the object names belonging to a particular range, which is a portion of the global name space, are object names corresponding to the objects having the particular correlation.

19. A storage virtualization system, wherein
at least one of a plurality of storage control devices constituting the storage virtualization system which presents a virtual name space, comprises:
a storage control device identification section which identifies two or more other storage control devices, of the plurality of storage control devices, which have an object corresponding to an object name belonging to a particular range comprising all or a portion of a virtual name space, on the basis of virtualization definition information which represents respective locations, within the storage virtualization system, of the objects corresponding to the object names in the virtual name space; and
a backup timing synchronization section which sends backup timing information which indicates backup timing for the object, to the identified two or more other storage control devices, wherein
each of the two or more other storage control devices having received the backup timing information, comprises:
a setting section which stores the received backup timing information in a storage extent; and
a backup section which backs up the object at timing indicated by the backup timing information stored in the storage extent.

20. A backup control method, wherein
same backup timing information is stored respectively in two or more storage control devices, of a plurality of storage control devices constituting a storage virtualization system which presents a virtual name space, two or more storage control devices having objects which correspond to object names belonging to a particular range which is all or a portion of the virtual name space, and
each of the two or more storage control devices respectively backs up the objects at timing indicated by the stored backup timing information.
